(19) United States
(12) Patent Application Publication
(10) Pub. No.: US 2026/0268598 A1
(43) Pub. Date: Sep. 10, 2026

(54) IMAGE PROCESSING DEVICE AND IMAGE PROCESSING METHOD

(71) Applicant: Sony Interactive Entertainment Inc., Tokyo (JP)

(72) Inventors: Kazuyuki Arimatsu, Tokyo (JP); Takayuki Shinohara, Tokyo (JP); Norihide Kaneko, Tokyo (JP); Xinyu Zhang, Tokyo (JP)

(73) Assignee: Sony Interactive Entertainment Inc., Tokyo (JP)

(21) Appl. No.: 19/662,342

(22) Filed: Apr. 29, 2026

Related U.S. Application Data
(63) Continuation of application No. PCT/JP2023/039244, filed on Oct. 31, 2023.

(51) Int. Cl. G06T 17/00; G06T 15/20

(52) U.S. Cl. CPC G06T 17/00; G06T 15/20

(57) ABSTRACT

In a main image output phase in which a content application is executed, a content server receives a user operation to save a scene being displayed. A plurality of pseudo-viewpoints are set for the scene, images for learning are generated, and machine learning is performed, thereby 3D scene information of the scene is generated. In a saved scene viewing phase, the content server generates and outputs a display image representing the scene from an arbitrary viewpoint using the 3D scene information.

This application is a continuation of International Patent Application No. PCT/JP2023/039244, filed on Oct. 31, 2023, the entire disclosure of which is incorporated herein by reference for all purposes.

### TECHNICAL FIELD

The present disclosure relates to an image processing device and an image processing method for processing a content image in which a user operation is reflected.

### BACKGROUND

In recent years, as a result of expansion of communication networks and development of the image processing technique, various kinds of electronic content have been enjoyed in any viewing environment. For example, in a field of electronic games, a system in which a server collects information concerning a state of each client terminal such as a user operation description or positional information, and delivers image data in which the information is reflected as required, to allow a plurality of players to join the same game from everywhere, has spread.

In recent years, as a result of development of machine learning techniques such as deep learning, a technique of acquiring various information from images has become commonplace. For example, one of techniques for expressing a three-dimensional space using a neural network is neural radiance fields (NeRF). In NeRF, a neural network is used to express a volume density and radiation luminance of an object in a three-dimensional space by a five-dimensional function including position coordinates and directions. For example, if an NeRF expression is obtained on the basis of images of an object captured from a plurality of directions, appearance of the object viewed from an arbitrary viewpoint can be expressed by volume rendering (for example, see Ben Mildenhall, et.al., “NeRF: Representing Scenes as Neural Radiance Fields for View Synthesis,” Communications of the ACM, January 2022, Vol. 65, No. 1, pages 99-106).

### SUMMARY

According to image processing using the above-mentioned machine learning, an image having a high degree of freedom can be obtained from limited information. However, learning using proper and sufficient images is necessary. This presents a problem that an application range is limited. For example, in content in which a scene being displayed changes in real time in accordance with a user operation, there is a problem, e.g., at which timing an image to be learned is acquired with respect to a scene which is changing from moment to moment, how to use the learned information, etc. Thus, it is not easy to introduce the image processing.

The present disclosure has been made in view of the above problem, and an object thereof is to provide a technique of acquiring three-dimensional information in a display world in content in which a state of the display world can change in accordance with a user operation. Another object of the present disclosure is to realize a new function using three-dimensional information which is obtained by applying machine learning to the above content.

In order to solve the above problem, a certain aspect of the present disclosure relates to an image processing device. The image processing device includes a main image generation section that generates a frame of a display image at a predetermined rate, the display image representing a three-dimensional display world, a state of which changes in accordance with a user operation from a supplied viewpoint, a pseudo-viewpoint generation section that generates a pseudo-viewpoint different from the viewpoint defining the display image and causes an image for learning to be generated by supplying the generated pseudo-viewpoint to the main image generation section, and a three-dimensional (3D) scene information generation section that generates 3D scene information by machine learning using the image for learning as training data, the 3D scene information representing three-dimensional information concerning the display world.

Another aspect of the present disclosure relates to an image processing method. The image processing method includes a step of generating a frame of a display image at a predetermined rate, the display image representing a three-dimensional display world, a state of which changes in accordance with a user operation from a supplied viewpoint, a step of generating a pseudo-viewpoint different from the viewpoint defining the display image and an image for learning corresponding to the pseudo-viewpoint, and a step of generating 3D scene information by machine learning using the image for learning as training data, the 3D scene information representing three-dimensional information concerning the display world.

It is to be noted that a method, an apparatus, a system, a computer program, a data structure, or a recording medium which is obtained by translating an arbitrary combination of the above constituent elements or an expression in the present disclosure, is also effective as an aspect of the present disclosure.

According to the present disclosure, in content in which the state of a display world can change in accordance with a user operation, three-dimensional information in the display world can be acquired by machine learning. Further, according to the present disclosure, a new function can be realized using three-dimensional information obtained by applying machine learning to the content.

### BRIEF DESCRIPTION OF DRAWINGS

FIG. 1 is a diagram depicting a configuration example of an image display system to which the present embodiment can be applied.

FIG. 2 is a diagram depicting an internal circuit configuration of a client terminal in the present embodiment.

FIG. 3 is a diagram depicting a basic flow of image processing in the present embodiment in comparison with a conventional technique.

FIG. 4 is a diagram depicting an outline of a process flow in an aspect in which a scene desired by a user is saved in a form of 3D scene information.

FIG. 5 is a diagram depicting a functional block configuration of a client terminal and a content server that realizes scene saving in the present embodiment.

FIG. 6 is a diagram schematically depicting a sequence of images generated in a main image output phase of the present embodiment.

FIG. 7 is a diagram illustrating arrangement of pseudo-viewpoints generated by a pseudo-viewpoint generation section in the present embodiment.

FIG. 8 is a diagram schematically depicting switching between a main image and a standby image which are displayed on a display device in the present embodiment.

FIG. 9 is a diagram for illustrating that a 3D scene information generation section extracts a region for learning from an image for learning in the present embodiment.

FIG. 10 is a diagram depicting the outline of a process flow in an aspect in which 3D scene information is used to correct a display image.

FIG. 11 is a diagram for illustrating reprojection as an example of correction of a main image in the present embodiment.

FIG. 12 is a diagram depicting a functional block configuration of a client terminal and a content server that realizes correction of a display image in the present embodiment.

FIG. 13 is a diagram schematically depicting a sequence of images generated in the present embodiment.

FIG. 14 is a diagram for illustrating that a left-eye image and a right-eye image to be displayed on a head mounted display are generated in the present embodiment such that the display viewpoints are deviated from each other.

FIG. 15 is a diagram depicting the outline of a process flow in an aspect in which 3D scene information is used to deliver a replay image.

FIG. 16 is a diagram depicting a functional block configuration of a client terminal and a content server that realizes delivery of a replay image in the present embodiment.

FIG. 17 is a diagram schematically depicting a sequence of images generated in a main image output phase of the present embodiment.

FIG. 18 is a diagram illustrating a screen that is displayed by an additional viewpoint setting section of the content server to receive user setting of an additional viewpoint in the present embodiment.

FIG. 19 is a diagram illustrating a heat map generated by a heat map generation section of the content server in the present embodiment.

FIG. 20 is a diagram illustrating a replay image display screen to be displayed on the display device in a replay image delivery phase in the present embodiment.

FIG. 21 is a diagram depicting a functional block configuration of the content server in an aspect in which a display viewpoint is restricted by an application.

FIG. 22 is a diagram illustrating a data structure of 3D scene information data in the present embodiment.

### DETAILED DESCRIPTION

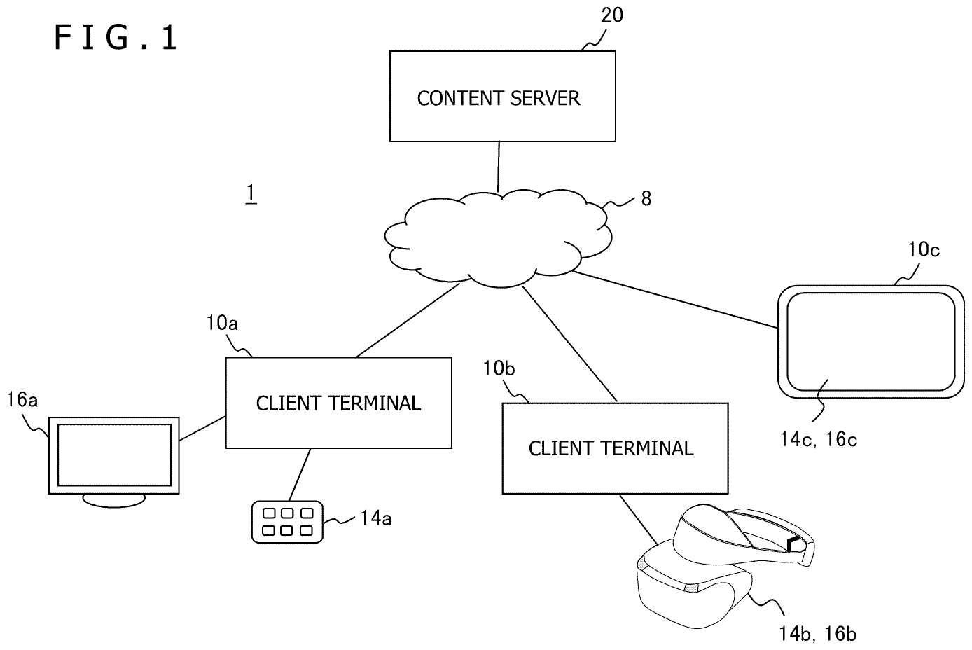

FIG. 1 depicts a configuration example of an image display system to which the present embodiment can be applied. An image processing system 1 includes client terminals 10a, 10b, and 10c on which images are displayed in accordance with a user operation or the like, and a content server 20 that provides image data to be used for display. Input devices 14a, 14b, and 14c for receiving user operations and display devices 16a, 16b, and 16c for displaying images are connected, respectively, to the client terminals 10a, 10b, and 10c. Between the client terminals 10a, 10b, and 10c and the content server 20, communication can be established via a network 8 such as world area network (WAN) or local area network (LAN).

Connection between the client terminals 10a, 10b, and 10c, the display devices 16a, 16b, and 16c, and the input devices 14a, 14b, and 14c may be established by wires or by wireless. Alternatively, two or more of these devices may be integrally formed. For example, in the drawing, the client terminal 10b is connected to a head mounted display which is the display device 16b. The view filed of a display image on the head mounted display can be changed according to motion of a user wearing the head mounted display on the head. Thus, the head mounted display also functions as the input device 14b.

In addition, the client terminal 10c is a mobile terminal, a tablet terminal, or the like, and is formed integrally with the display device 16c and the input device 14c which is a touch pad covering a screen of thereof. Thus, appearances of the depicted devices and the connection form therebetween are not limited. The number of the client terminals 10a, 10b, and 10c and the number of the content servers 20 to be connected to the network 8 are also not limited. Hereinafter, the client terminals 10a, 10b, and 10c are collectively referred to as client terminal 10, the input devices 14a, 14b, and 14c are collectively referred to as input device 14, and the display devices 16a, 16b, and 16c are collectively referred to as display device 16.

The input device 14 is a common input device such as a controller, a keyboard, a mouse, a touch pad, or a joy stick, and receives a user operation and supplies the user operation to the client terminal 10. Alternatively, the input device 14 may be any sensor such as a motion sensor or a camera included in a head mounted display, a mobile terminal, a tablet terminal, or the like, and may supply sensor data to the client terminal 10. The display device 16 may be a common display such as a liquid crystal display, a plasma display, an organic electroluminescence (EL) display, a wearable display, or a projector. An image outputted from the client terminal 10 is displayed on the display device 16.

The content server 20 provides data about the content that requires image display, to the client terminal 10. The type of the content is not particularly limited, and may be any one of an electric game, a viewing image, a promotion image, a web page, a video chat using an avatar, and the like. In the present embodiment, the content server 20 basically realizes streaming by generating videos and sound data representing the content, and then transmitting the data to the client terminal 10 in real time.

Here, the content server 20 may successively acquire information regarding user operations performed on the input device 14 or sensor data acquired by any sensor from the client terminal 10, and reflect the information or data in images and sounds. Accordingly, a plurality of users are allowed to join the same game or communicate with each other in a virtual world. However, the configuration of the image processing system is not limited to that depicted in the drawing. By way of example, the subject of generating images is not limited to the content server 20. The image generation may be performed by the client terminal 10, or by cooperation of the content server 20 and the client terminal 10.

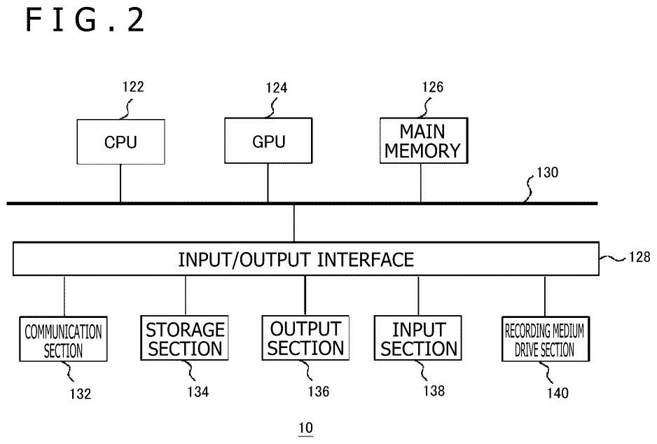

FIG. 2 is a diagram depicting an internal circuit configuration of the client terminal 10 in the present embodiment. The client terminal 10 includes a central processing unit (CPU) 122, a graphics processing unit (GPU) 124, and a main memory 126. These sections are mutually connected via a bus 130. An input/output interface 128 is further connected to the bus 130. A communication section 132 formed of a peripheral device interface supporting universal serial bus (USB) or the like, or a network interface of a wired or wireless LAN, a storage section 134 such as a hard disk drive or a nonvolatile memory, an output section 136 that outputs data to the display device 16, an input section 138 that receives data from the input device 14, and a recording medium drive 140 that drives a removable recording medium such as a magnetic disk, an optical disk, or a semiconductor memory are connected to the input/output interface 128.

The CPU 122 generally controls the client terminal 10 by executing an operating system stored in the storage section 134. The CPU 122 further executes various programs that are read from a removable recording medium and loaded into the main memory 126, or that are downloaded via the communication section 132. The GPU 124 has a geometry engine function and a rendering processor function. The GPU 24 performs rendering in accordance with a rendering command from the CPU 122 and stores display pictures into a frame buffer (not depicted). Then, the display images stored in the frame buffer are converted into video signals, and the video signals are outputted to the output section 136. The main memory 126 is formed of a random access memory (RAM). Programs and data required for processes are stored in the main memory 126. The content server 20 may also have the similar internal circuit configuration.

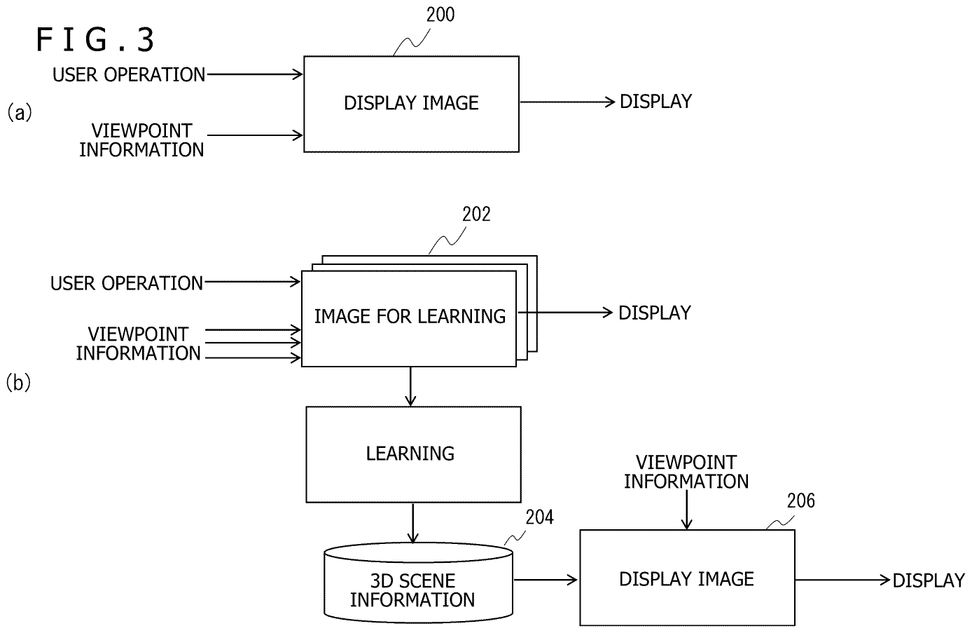

FIG. 3 is a diagram depicting a basic flow of image processing in the present embodiment in comparison with a conventional technique. Since a main process may be performed by either the content server 20 or the client terminal 10, or by cooperation of both, as described above, the main process will be described herein without distinguishing therebetween on the assumption that the process is performed by an “image processing device.” In the present embodiment, a three-dimensional space world where a various kinds of objects exist is a target to be displayed. The state of this world changes in accordance with the specifications of a program or the like and a user operation.

In a common process depicted in (a), the image processing device first successively acquires a user operation description, the position of a viewpoint to a display world, and information regarding a view line direction. Hereinafter, the entire three-dimensional space to be displayed is referred to as “display world,” and the state of the display world within or around a display visual field is referred to as “scene.” In addition, the position of a viewpoint and the view line direction with respect to the scene may be collectively referred to as “viewpoint.” The viewpoint may be adjusted manually by a user via the input device 14, or derived from motion of a user head by means of, e.g., a motion sensor included in the head mounted display.

The image processing device renders a display image 200 in a visual field corresponding to the viewpoint information while changing a scene according to a user operation. The image processing device generates the display image 200 by, e.g., a well-known computer graphics rendering technique such as ray tracing or rasterization, and outputs the display image 200 to the display device 16. The image processing device continuously generates the display images 200 at a predetermined frame rate, whereby a moving image is displayed so as to express the scene change based on a user operation or the like. That is, the display images 200 are moving image frames that can interactively change in accordance with a user operation and viewpoint information.

Hereinafter, a moving image that is generated in parallel with acquisition of a user operation and viewpoint information is referred to as “main image.” A typical example of the main image is a game image during play. The image processing device may concurrently acquire user operation descriptions from a plurality of users as in, e.g., a multiplayer game, and reflect them in the display image 200. Also in the present embodiment indicated by (b), the image processing device generates a main image in the same manner. On the other hand, in the present embodiment, the image processing device uses an image 202 for learning as a main image and uses the image 202 for learning as training data in machine learning. The image processing device generates 3D scene information 204 representing three-dimensional scene information by collecting the images 202 for learning and performing machine learning.

In a case where NeRF is adopted for machine learning, each viewpoint information, i.e., a virtual viewpoint position and a view line direction determined when an image 202 for learning is generated are inputted first, the corresponding image 202 for learning is used as training data, whereby data representing three-dimensional scene information is obtained by regression using a multilayer perceptron (MLP). This data is a neural network to which a five-dimensional parameter including position coordinates (x, y, and z) and a position vector d(θ and φ) in a three-dimensional space is inputted and from which a volume density σ and color information c (RGB) of three primary colors are outputted.

In the present embodiment, data of this neural network is referred to as “3D scene information.” However, any technique other than NeRF also can be introduced as long as three-dimensional information can be estimated from a plurality of two-dimensional images, that is, an expression form of the 3D scene information is not limited. In the present embodiment, the image 202 for learning is a main image. That is, the content of the image 202 for learning, that is, the 3D scene information 204 can change moment by moment. The drawing depicts that the 3D scene information 204 of a scene at a moment or in a very short period of time that can be regarded as a moment is generated.

To obtain the highly accurate 3D scene information 204, it is desirable that the image processing device collects, from as many viewpoints as possible, the images 202 for learning of a scene at a moment or in a very short period of time that can be regarded as a moment. Therefore, the image processing device collects the images 202 for learning, for example, in a manner described below.

(1) Generating a viewpoint suitable for learning in addition to a viewpoint defining the visual field of an image to be actually displayed, and generating a corresponding image.
(2) Using display images from different viewpoints to be delivered to a plurality of users viewing the same scene.

Hereinafter, a viewpoint generated by the image processing device itself in (a) is referred to as “pseudo-viewpoint,” and a viewpoint defining the actual display is referred to as “display viewpoint.” The image processing device may execute either one of (1) and (2), or may execute both of them. For example, (1) may be performed to compensate for insufficient viewpoints that cannot be provided by (2). In any case, the images 202 for learning may include general display images 200 such as those depicted in (a) in the drawing. Accordingly, the image processing device may output at least part of the images 202 for learning as display images to the display device 16.

Alternatively, the image processing device may use the 3D scene information 204 to additionally generate the display image 206 or correct the display image. Since the 3D scene information 204 is used, a scene viewed from an arbitrary viewpoint can be expressed in high quality and with a relatively low load. In a case where NeRF is adopted, the image processing device generates a ray r to pass through a pixel on a view screen from a display viewpoint, and obtains a pixel value C(r) on the display image by volume rendering in which colors are integrated along the direction of the ray.

$$C ( r ) = {\int }_{{t}_{n}}^{{t}_{f}} T ( t ) σ ( r ( t ) ) c ( r ( t ) , d ) dt \qquad [ Math . 1 ]$$

Herein, tₙ and t_{f} represent a proximal side and a distal side of the ray r, and T(t) represents a cumulative transmittance in the direction of the ray. T(t) is expressed as follows.

$$T ( i ) = exp ( {\int }_{{t}_{n}}^{t} σ ( r ( s ) ) d s ) \qquad [ Math . 2 ]$$

It is to be noted that a basic method of NeRF is disclosed in NPL 1, for example, and further, various kinds of improved methods thereof have been proposed, so that any one of them can be used in the present embodiment. Detailed explanations of these methods are omitted herein. The image processing device may generate single 3D scene information 204 that represents a scene at a moment or in a very short period of time, or may constantly update the 3D scene information 204 at a predetermined rate by repeating the processing depicted in the drawing. In the former case, using the 3D scene information 204, the image processing device can express the scene at a moment taken from the main image from an arbitrary viewpoint. In the latter case, the time-series order is also saved in a group of the 3D scene information sets. Therefore, the image processing device generates the display image 206 by giving the corresponding time to the 3D scene information for use, so that a moving image including a change comparable to that in a main image can be expressed from an arbitrary viewpoint.

For example, at a timing that is not in the main image display period, such as after the end of the game, the image processing device executes a display using the 3D scene information 204 in accordance with a user request, and receives a user operation for the display viewpoint. Accordingly, a function can be provided of, for example, allowing the user to view a momentary scene saved as the 3D scene information 204 by the user during game play from various directions after the end of the play, and allowing such a scene to be shared by another user. In addition, the image processing device can provide a function of delivering a replay moving image that can be viewed from a free viewpoint.

In a case where the 3D scene information 204 is constantly updated at a predetermined rate, the image processing device may use the 3D scene information 204 to make a correction for displaying a main image. For example, in an aspect where a streaming-delivered image is viewed through a head mounted display, the image processing device uses the 3D scene information 204 to correct the image according to the position and posture of a user head immediately before display. Hereinafter, example aspects that can be implemented by the present embodiment will be explained. It is to be noted that each aspect will be separately explained for simplicity, but two or more of the aspects may be actually combined.

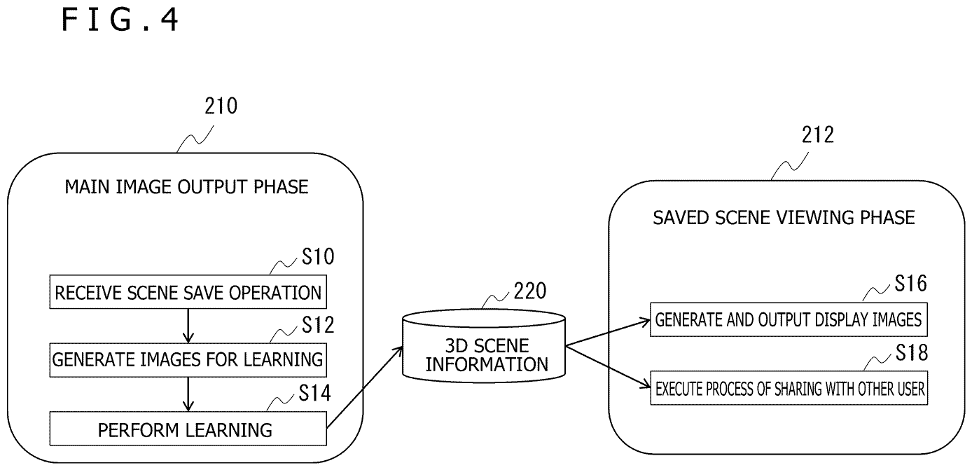

FIG. 4 depicts the outline of a process flow in an aspect in which a scene desired by a user is saved in a form of 3D scene information. The present aspect is realized by two separate periods which are a main image output phase 210 and a saved scene viewing phase 212. The main image output phase 210 is a period in which a main image of the content is being outputted, such as a period during a game play. In this period, the image processing device or, e.g., the content server 20 receives a user operation for scene saving (S10).

In response to this, the content server 20 generates images for learning of a scene at the time point of the user operation from a plurality of viewpoints (S12), and generates the 3D scene information 220 representing the scene by performing machine learning (S14). It is to be noted that, in actuality, generation of images for learning and learning using the images for learning may be concurrently performed. The saved scene viewing phase 212 is started at any timing such as after the end of a game play, when a user request for viewing is given. During this phase, the image processing device, e.g., the content server 20 generates an image of the scene using the saved 3D scene information 220, and outputs the image for display (S16).

Alternatively, the content server 20 executes a process of sharing the saved scene with other users in accordance with a user request (S18). For example, using the existing social networking service (SNS) mechanism, the content server 20 transmits the image of the scene to the client terminal 10 of a different user designated by the sharing source user. In any case, using the 3D scene information 220, the content server 20 generates a display images of the scene while changing the display viewpoint in accordance with viewpoint adjustment performed by the user who is viewing the image.

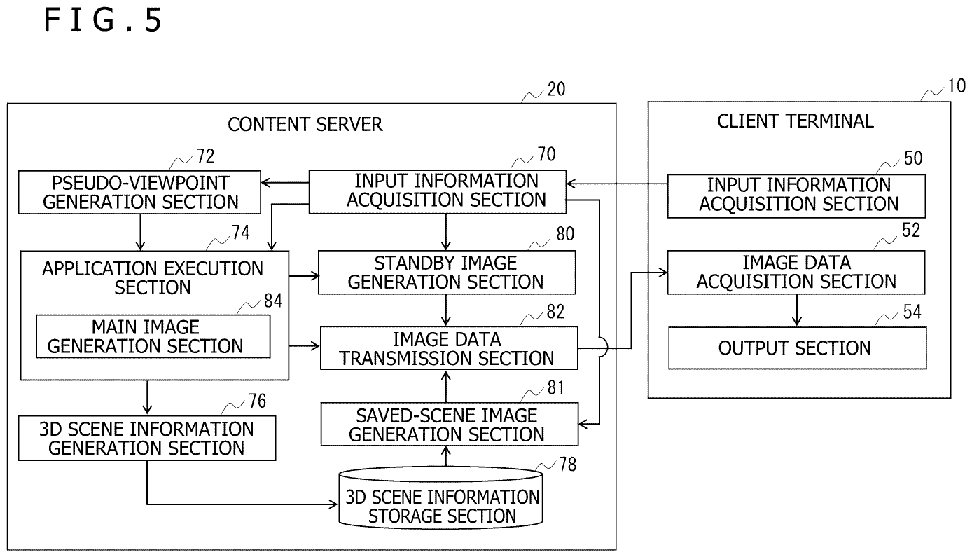

FIG. 5 depicts a functional block configuration of the client terminal 10 and the content server 20 that realizes scene saving. The functional blocks depicted in FIGS. 5, 12, 16, 21, and 23 can be implemented by hardware using the CPU, the GPU, and the memories depicted in FIG. 2, and can be implemented by software using a program that is loaded from a recording medium or the like onto a memory to exert functions such as a data input function, a data retaining function, an image processing function, and a communication function. Therefore, a person skilled in the art will understand that these functional blocks can be implemented in many different ways, for example, by means of hardware only, by means of software only, or by a combination thereof. These functional blocks are not limited to any one of them. In addition, the content server 20 plays a key role of the image processing in the following explanation, but at least a part of the processing may be performed by the client terminal 10.

The client terminal 10 includes an input information acquisition section 50 that acquires information such as a user operation, an image data acquisition section 52 that acquires image data from the content server 20, and an output section 54 that outputs display image data. The input information acquisition section 50 successively acquires a description of a user operation description from the input device 14. The user operations include a selection of content, startup of content, and a command input to content under execution. In addition, the information acquisition section 50 receives an operation for saving a desired scene of the content main image, and an operation of requesting for viewing or sharing of the saved scene with other users. In the present embodiment, designating a timing is necessary and sufficient for an operation for saving a scene. Therefore, it is preferable that the operation is realized by a simple operation such as depressing a button on the input device 14.

Further, the input information acquisition section 50 acquires the display viewpoint information from the input device 14 or a head mounted display, if needed or at a predetermined time interval. A technique for detecting the position and posture of a user head with a head mounted display mounted thereon, and acquiring display viewpoint information on the basis of the position and posture is well known. This technique can be adopted also in the present embodiment. Here, the display viewpoints include a display viewpoint for the main image, and a display viewpoint for viewing a saved scene. The input information acquisition section 50 supplies the acquired information to the content server 20, if needed.

The image data acquisition section 52 acquires display image data from the content server 20. Here, the display image data may include main image data, image data about the saved scene, and standby image data for a period of learning a scene to be saved. The output section 54 outputs the display image acquired by the image data acquisition section 52 to the display device 16 to display the display image.

The content server 20 includes an input information acquisition section 70 that acquires input information from the client terminal 10, a pseudo-viewpoint generation section 72 that generates a pseudo-viewpoint for generating an image for learning, an application execution section 74 that executes an application such as an electronic game, a 3D scene information generation section 76 that generates 3D scene information data, a 3D scene information storage section 78 that stores the generated 3D scene information data, a standby image generation section 80 that generates a standby image which indicates a generation period for an image for learning, a saved-scene image generation section 81 that generates an image representing a saved scene, and an image data transmission section 82 that transmits display image data to the client terminal 10.

The input information acquisition section 70 acquires a user operation description and display viewpoint information from the client terminal 10 successively or a predetermined time interval. The input information acquisition section 70 basically supplies the acquired information to the application execution section 74. When acquiring a user operation for scene saving, the input information acquisition section 70 supplies this information and the latest display viewpoint information also to the pseudo-viewpoint generation section 72. When doing so, the pseudo-viewpoint generation section 72 generates a pseudo-viewpoint for generating an image for learning on the basis of the latest display viewpoint. The pseudo-viewpoint generation section 72 supplies the generated pseudo-viewpoint information to the application execution section 74.

The application execution section 74 processes the content application such as an electronic game in accordance with a user operation description in the main image output phase. The application execution section 74 includes a main image generation section 84 to generate main image frames corresponding to a display viewpoint at a predetermined frame rate. Further, when a user operation for scene saving is given, the main image generation section 84 generates, as an image for learning, an image of the scene viewed from the pseudo-viewpoint generated by the pseudo-viewpoint generation section 72.

In the depicted example, it is assumed that the application execution section 74 generates a main image basically on the basis of the viewpoint information supplied from the input information acquisition section 70. In this case, the pseudo-viewpoint generation section 72 generates pseudo-viewpoint information in the same form as that of the viewpoint information supplied from the input information acquisition section 70, and supplies the pseudo-viewpoint information to the application execution section 74. Accordingly, the application execution section 74 can generate images for learning by normal processing without distinguishing between a true display viewpoint and a pseudo-viewpoint. Consequently, the present embodiment also can be easily introduced to conventional content that is not designed for machine learning.

The present embodiment is, however, not limited to this. An application programming interface (API) having a function of generating pseudo-viewpoints may be prepared, and designated under an application program, so that the application execution section 74 includes the pseudo-viewpoint generation section 72. In either case, it is desirable that the application execution section 74 suspends the progress of the content until a sufficient number of images for learning are generated by the main image generation section 84. Accordingly, as a static scene, a scene at the point of time when the user performs a saving operation is used to generate a sufficient amount of images for learning, so that 3D scene information can be generated with high accuracy.

In a case where the progress of the content is suspended, the application execution section 74 resumes the progress of the content when images corresponding to all the pseudo-viewpoints are generated. In the main image output phase, the 3D scene information generation section 76 acquires the images for learning generated by the application execution section 74, and performs the above-mentioned machine learning to generate 3D scene information of the scene to be saved. It is to be noted that the 3D scene information generation section 76 may extract a region to be saved from an image for learning generated by the main image generation section 84, and uses only the extracted region for machine learning.

The 3D scene information storage section 78 stores the 3D scene information generated by the 3D scene information generation section 76. The 3D scene information storage section 78 stores the 3D scene information in association with identification information concerning a user having requested for scene saving and save timing information on the time axis of the main image. Accordingly, a scene to be displayed can be easily retrieved in the saved scene viewing phase. When a user operation for scene saving is given in the main image output phase, the standby image generation section 80 generates a standby image to be displayed during image learning. When the standby image is displayed, the user can recognize that scene saving is in progress. In addition, in a case where a head mounted display is adopted as the display device 16, motion sickness which may be caused when a scene is suspended and the view field stops to follow motion of the head, can be reduced.

When a user operation requesting for saved scene viewing is given in the saved scene viewing phase, the saved-scene image generation section 81 generates a display image representing the scene by the above-mentioned volume rendering using the 3D scene information stored in the 3D scene information storage section 78. Here, the saved-scene image generation section 81 acquires the display viewpoint from the input information acquisition section 70, and accordingly generates the display image while changing the viewpoint for the saved scene. In the main image output phase, the image data transmission section 82 sequentially transmits the main image data generated by the main image generation section 84 and the standby image generated by the standby image generation section 80 to the client terminal 10.

Further, in the saved scene viewing phase, the image data transmission section 82 transmits image data about a saved scene generated by the saved-scene image generation section 81 to the client terminal 10. When a user operation for saved scene sharing with another user is given, the image data transmission section 82 transmits the saved scene image data to the client terminal 10 of the sharing partner. In this case, a common SNS platform can be used actually. Therefore, a detailed functional block is omitted in the drawing.

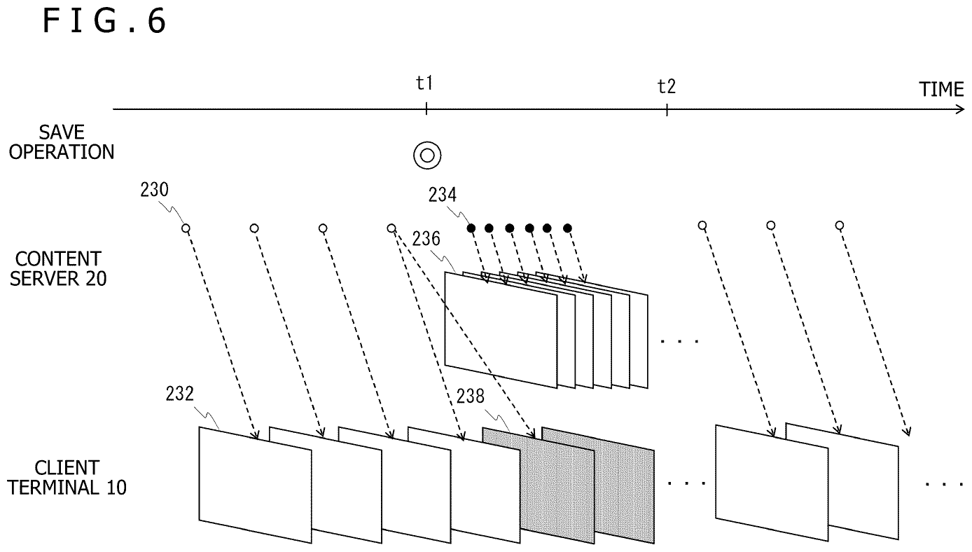

FIG. 6 schematically depicts a sequence of images generated in the main output phase of the present embodiment. In FIG. 6, a relation between a viewpoint recognized or generated by the content server 20 and the destination of each frame generated based on this viewpoint is depicted along a time axis in the horizontal direction. The content server 20 basically generates frames of a display image (e.g., frames 232) to correspond to the display viewpoints (e.g., display viewpoints 230) which are indicated by white circles, at a predetermined rate, and transmits the generated frames to the client terminal 10.

Accordingly, when a scene to be saved comes in the main image displayed on the client terminal 10 side, the user performs a scene saving operation by, for example, depressing a predetermined button on the input device 14. When this operation for saving is performed at time t1 in the drawing, the content server 20 generates pseudo-viewpoints (e.g., pseudo-viewpoints 234) indicated by black circles, and generates images for learning (e.g., images 236 for learning) to correspond to the pseudo-viewpoints. During a period in which the content server 20 generates the images for learning, generation of the frames of the display image is suspended. As depicted in the drawing, a rate of generating the images for learning may be higher than the rate of the display frames according to the processing performance of the content server 20.

In one example, in a case where the rendering performance of the main image generation section 84 is 120 fps, if 120 pseudo-viewpoints are prepared and are sequentially processed by the main image generation section 84, 120 images for learning can be generated per second. During a period in which the content server 20 generates the images for learning, the content server 20 suspends the progress of the content, and further, generates standby images (e.g., standby images 238) hatched in the drawing, and transmits the standby images to the client terminal 10. The standby image may be a static image or a moving image, as described above. Alternatively, the standby images may be generated at the client terminal 10 side. The standby images are continuously displayed until time t2 when the content server 20 completes generation of a predetermined number of images for learning. In an environment where 120 images for learning can be generated per second as described above, a few seconds are sufficient as a display time period of the standby image.

The content server 20 generates 3D scene information of a scene on the basis of the images for learning having been generated by time t2, and stores the 3D scene information in the 3D scene information storage section 78. The content server 20 resumes the progress of the content at time t2, and then generates frames of a display image corresponding to the latest display viewpoint at a predetermined rate, and transmits the frames of the display image to the client terminal 10.

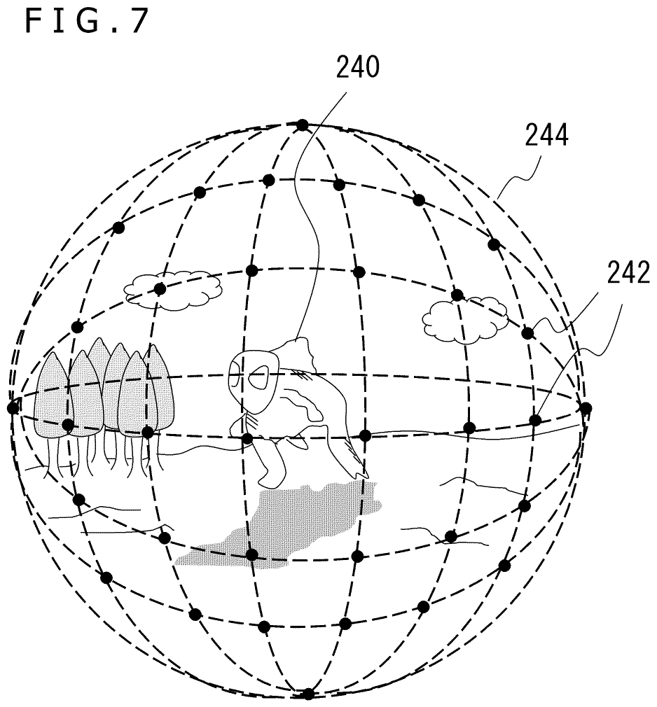

FIG. 7 illustrates arrangement of pseudo-viewpoints generated by the pseudo-viewpoint generation section 72. In this example, a plurality of pseudo-viewpoints (e.g., viewpoints 242) are arranged so as to surround a scene of, e.g., an object 240 included in the display view field at a point of time when an operation for scene saving is given. For example, the pseudo-viewpoint generation section 72 arranges the pseudo-viewpoints at equal spacings on a surface of a sphere 244 having a predetermined radius and having its center at a position, in the scene, corresponding to the center of the display view field. Further, a view line is defined from each pseudo-viewpoint toward the center of the sphere 244.

Accordingly, images for learning representing a scene viewed by the user when the saving operation is performed can be generated from many different directions. However, the arrangement of pseudo-viewpoints is not limited to the arrangement depicted in the drawing. For example, in a case where a ground surface is included in the scene, a hemisphere may be introduced in place of the sphere 244 such that only an area above the ground becomes effective. In addition, a surface on which viewpoints are arranged is not limited to the sphere, and a surface of any one of a rectangle, a circular cylinder, an ellipsoid body, etc., may be adopted. The surface does not need to be a surface of a specific three-dimensional object. In addition, the viewpoints are not necessarily arranged at equal spacings. The distribution of the viewpoints may have a deviation such that, for example, more viewpoints are arranged in an area where a display viewpoint is highly likely to be located or in an area where a key object can be viewed in the saved scene viewing phase. Accordingly, highly accurate 3D scene information in a region of importance can be efficiently generated.

In addition, the pseudo-viewpoint generation section 72 may set pseudo-viewpoints on surfaces of a plurality of three-dimensional objects. For example, the pseudo-viewpoint generation section 72 may arrange the pseudo-viewpoints, respectively, on surfaces of concentric circles of different sizes. Accordingly, images for learning representing a scene viewed at many different distances can be generated. The direction of the view line is not limited to the center of the scene. For example, the pseudo-viewpoint generation section 72 may set view lines so as to extend radially from, as a start point, a virtual position of the user in the scene.

Accordingly, 3D scene information that can be adapted when the display view field is largely rotated, can be generated in the saved scene viewing phase. In any case, as the number of pseudo-viewpoints is increased, the accuracy of resultant 3D scene information can become higher, whereby the quality of the display image is enhanced. However, a time required to generate images for learning and the usage amount in the memory are also increased. For this reason, it is desirable that the number of pseudo-viewpoints generated by the pseudo-viewpoint generation section 72 is determined according to the processing performance of the content server 20, the content of the scene, and an objective of generating 3D scene information.

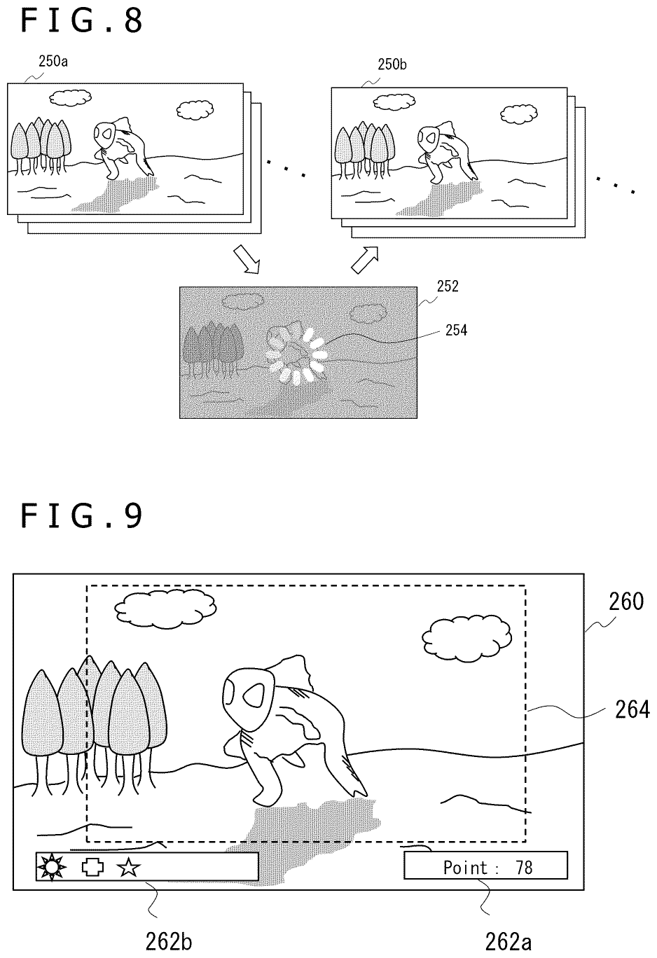

FIG. 8 schematically depicts switching between a main image and a standby image which are displayed on the display device 16 in the present embodiment. In the progress of the main content, for example, during a game play, main image frames 250a are displayed on the display device 16 at a predetermined rate, as described above. In contrast, when the user performs an operation for scene saving at a certain timing, the display is switched to a standby image 252. In the depicted example, the chroma and brightness of the main image frame 250a displayed at the time of the operation for saving are reduced, and a progress indicator 254 that indicates that the processing is in progress is displayed.

However, the configuration of the standby image is not limited that depicted in the drawing, and a simple filled image may be adopted or an image not including the image of the frame 250a may be adopted. Alternatively, certain processing may be performed on the image of the frame 250a itself. After images for learning are generated, the display is resumed from the next main image frame 250b.

FIG. 9 is a diagram for illustrating that the 3D scene information generation section 76 extracts a region for learning from an image for learning in the present embodiment. In this example, on the main image 260 generated by the main image generation section 84 of the application execution section 74, not only a scene image but also supplemental images necessary for the content, e.g., a section 262a that indicates a game point and a section 262b that indicates an icon of a possessed tool are superimposed. In a case where the main image generation section 84 generates images without distinguishing between a display viewpoint and a pseudo-viewpoint, there is a possibility that an image for learning has the same structure. Therefore, the 3D scene information generation section 76 excludes a region representing a supplementary image, and uses only a region representing a scene itself for machine learning.

Accordingly, a problem that excess information is included in the 3D scene information or a problem that a false object is generated can be eliminated. The size and position of the region 264 can be determined in advance on the basis of the size and position of a superimposed supplementary image. However, grounds for determining the region 264 are not limited to the presence of the supplementary image, and the appropriateness of a scene to be viewed later may be taken into consideration. For example, a region to be extracted in the main image being displayed may be widened or narrowed according to the range occupied by the image of a key object. That is, a region to be extracted may be fixed, or may be varied according to change of the displayed content.

According to the above-mentioned aspect in which a scene desired by a user is saved, the content server 20 performs machine learning to generate 3D scene information of the scene in accordance with a user operation for scene saving at a certain timing of the main image being displayed. Accordingly, the user can view a momentary scene in the progress of the content, from an arbitrary viewpoint another time. In addition, the saved scene can be shared with another user such as a friend. Since the saved scene can be viewed from an arbitrary viewpoint, the saved state can be reviewed or examined with high reality which has not been attained by a conventional technique of capturing a screenshot of an image or the like.

In the scene saving, a number of pseudo-viewpoints are generated according to the display state at the corresponding point of time, and images for learning are intensively generated. Accordingly, the user who has no technical knowledge can efficiently generate images suitable for learning by a simple operation, and thus, can generate highly accurate 3D scene information within a short period of time. In addition, since the mechanism of generating pseudo-viewpoint information in the same form as in the normal application process and causing images for learning to be generated by supplying the information to the application side is provided, the present aspect can be easily applied to a conventional application that is not designed for machine learning.

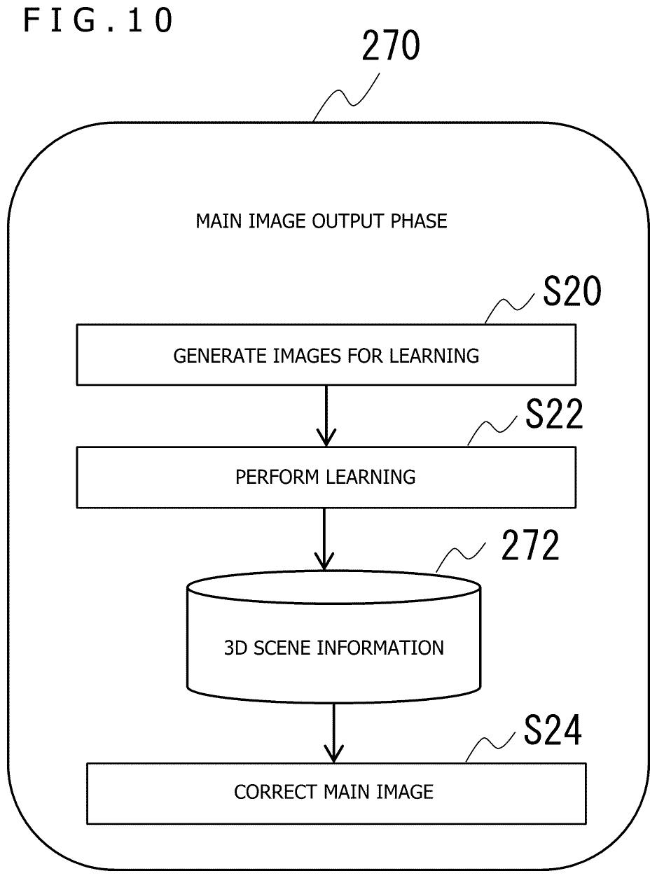

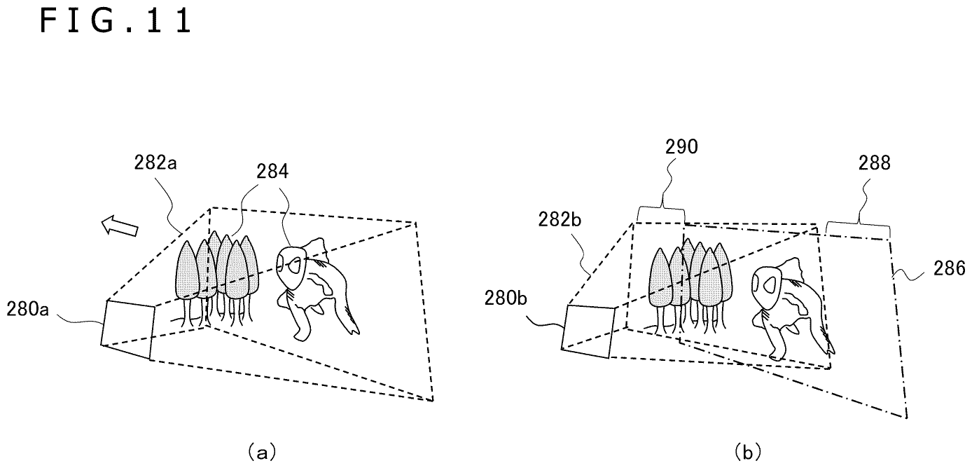

FIG. 10 depicts the outline of a process flow in an aspect in which 3D scene information is used to correct a display image. The present aspect is implemented in a main image output phase 270 in which a main image of the content is being outputted, for example, during a game play. In this period, the image processing device, e.g., the content server 20 generates an image for learning as well as a main image to be displayed (S20), and performs machine learning to generate 3D scene information 272 representing a scene at each time step (S22). That is, the 3D scene information 272 is updated with the lapse of time. Then, the image processing device, e.g., the client terminal 10 corrects the main image to be displayed, using the latest 3D scene information 272 (S24). Since an image generated from two-dimensional information is corrected using 3D scene information which has three-dimensional information, the correction can be made with high accuracy, whereby the quality of the display image is increased.

FIG. 11 is a diagram for explaining reprojection as an example of correcting a main image. Reprojection refers to processing of correcting a main image that has been generated, so as to have a view field adjusted to the position and posture of the user head, if, for example, a head mounted display is used as the display device 16. In a case where a main image generated at the content server 20 is displayed on the client terminal 10, a certain time of period is required from a time point when the content server 20 recognizes the display viewpoint to a time point when the corresponding frame generated is displayed on the client terminal 10 side, as depicted in FIG. 6. In actuality, a time to transmit the display viewpoint from the client terminal 10 to the content server 20 is further required.

This results in occurrence of a delay in the view field of the main image to be displayed, with respect to the actual change in the display viewpoint, so that discomfort that cannot be overlooked is caused. Particularly in a case where the display device 16 is a head mounted display, an immersion feeling into a virtual reality is impaired or motion sickness is induced, whereby the quality of a user experience is deteriorated. Therefore, the client terminal 10 corrects the main image frames transmitted from the content server 20 to the view field immediately before display.

In (a) of FIG. 11, the content server 20 generates a main image. The content server 20 sets a view screen 280a so as to correspond to a display viewpoint recognized at that moment, and renders images 284 included in a corresponding view frustum 282a on the view screen 280a. It is assumed that a viewpoint during display is shifted to a left side, as indicated by an arrow. In this case, the client terminal 10 corrects the image to obtain a view field that is shifted from the view screen 280b to the left side, as depicted in (b).

A view frustum 282b corresponding to the new defined view screen 280b does not include a region 288 of the view field 286 of the transmitted main image but include a new region 290. Therefore, the client terminal 10 discards an image of the region 288 and additionally renders an image of the region 290 which is now required, whereby obtains a corrected display image. In this case, the client terminal 10 additionally renders the image using the latest 3D scene information generated by the content server 20. Accordingly, a high quality image considering color changes caused by movement of the viewpoint or the like can be generated.

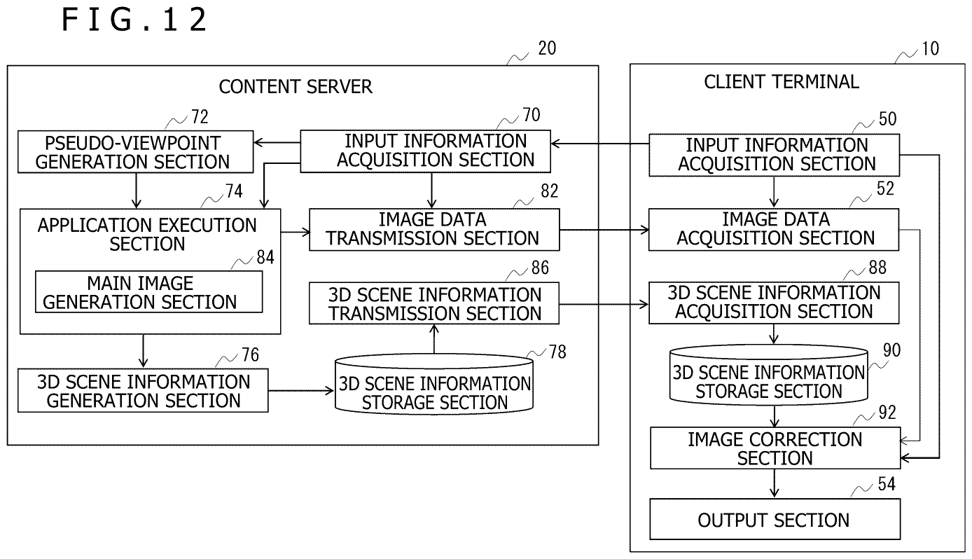

FIG. 12 depicts the functional block configurations of the client terminal 10 and the content server 20 that realize correction of display images. It is to be noted that a block having the same function as the functional block depicted in FIG. 6 is denoted by the same reference sign, and an explanation thereof will be omitted, if needed. The client terminal 10 includes an input information acquisition section 50 that acquires input information regarding a user operation or the like, an image data acquisition section 52 that acquires image data from the content server 20, a 3D scene information data acquisition section 88 that acquires 3D scene information data from the content server 20, 3D scene information storage section 90 that stores 3D scene information data, an image correction section 92 that corrects, using 3D scene information, a display image, and an output section 54 that outputs display image data.

The input information acquisition section 50 acquires information concerning a user operation and a display viewpoint such as those described above, and supplies the acquired information to the content server 20 and the image correction section 92, if needed. The image data acquisition section 52 acquires each frame data of a main image from the content server 20. The 3D scene information data acquisition section 88 sequentially acquires 3D scene information data which is constantly generated at a predetermined step, from the content server 20. The 3D scene information storage section 90 stores the 3D scene information data acquired by the 3D scene information data acquisition section 88.

The image correction section 92 corrects a main image transmitted from the content server 20 using 3D scene information data stored in the 3D scene information storage section 58. That is, as described above, the image correction section 92 acquires the latest display viewpoint from the input information acquisition section 50, and additionally renders an image of a lacking region in the corresponding visual field using 3D scene information. Therefore, the content server 20 transmits the main image data with a time stamp added, and the image correction section 92 acquires a change amount of the display viewpoint on the basis of the time difference between the time stamp and a correction time, and then identifies a lacking part in the display image.

Further, the image correction section 92 performs rendering using the latest 3D scene information for this lacking region. The image correction section 92 further excludes a region outside the view field from main image frames transmitted from the content server 20, and then generates a display image by connecting a region rendered by itself to the remaining region. However, corrections that are made by the image correction section 92 are not limited to addition or deletion of a view field. For example, for an object that is located at a short distance and is susceptible to a viewpoint change and a region in the vicinity thereof, the image correction section 92 may render an image using the 3D scene information again. Accordingly, an image in which a color has been adjusted to correspond to a change of the viewpoint can be displayed. Alternatively, the image correction section 92 may render an entire display image using the 3D scene information.

After the 3D scene information corresponding to a scene transition is prepared using machine learning, a high quality image can be rendered with a lower load, compared with normal processing such as ray tracing, even if the client terminal 10 generates a display image. When this fact is used, on the premise that to allow the client terminal 10 side to finally generate a display using the 3D scene information, there is no necessity for the content server 20 to generate a main image exactly corresponding to the display viewpoint. Therefore, the content server 20 may generate a main image from a viewpoint intentionally deviated from the display viewpoint such that the efficiency of collecting images for learning is increased.

In one example, in a case where the display device 16 is a head mounted display, the image correction section 92 may render at least one of a left-eye main image and a right-eye main image using the 3D scene information on the basis of the latest display viewpoint. Accordingly, it is unnecessary to impose, on the content server 20, a constraint condition that a pair of left-eye and right-eye main images which have high redundancy are normally generated. For example, the content server 20 sets the distance between the left and right viewpoints to be wider than the actual one, and generates a main image in which a view field overlapping is small. Accordingly, a variety of images for learning can be collected within a short period of time. The output section 54 outputs the display image corrected or generated by the image correction section 92, to the display device 16 to display the image.

The content server 20 includes an input information acquisition section 70 that acquires input information from the client terminal 10, a pseudo-viewpoint generation section 72 that generates a pseudo-viewpoint for generating an image for learning, an application execution section 74 that executes an application such as an electronic game, a 3D scene information generation section 76 that generates 3D scene information data, a 3D scene information storage section 78 that stores the generated 3D scene information data, an image data transmission section 82 that transmits the main image data to the client terminal 10, and a 3D scene information data transmission section 86 that transmits the 3D scene information data to the client terminal 10.

The input information acquisition section 70 acquires a user operation description and display viewpoint information from the client terminal 10 successively or a predetermined time interval, and supplies these kinds of information to the application execution section 74. The input information acquisition section 70 further supplies the display viewpoint information to the pseudo-viewpoint generation section 72. The pseudo-viewpoint generation section 72 generates a pseudo-viewpoint for generating an image for learning on the basis of the latest display viewpoint. In the present aspect, since 3D scene information of a scene is being learned while a main image is displayed, an opportunity to generate images for learning is restricted.

For this reason, the input information acquisition section 70 may supply the display viewpoint information acquired at that point of time, only to the pseudo-viewpoint generation section 72, and the pseudo-viewpoint generation section 72 may purposely supply a viewpoint shifted from the display viewpoint or supply an additional pseudo-viewpoint to the application execution section 74. The pseudo-viewpoint generation section 72 may predict a subsequent display viewpoint on the basis of the history of change of the display viewpoint until then, and generate pseudo-viewpoints so as to be accordingly distributed.

The application execution section 74 processes the application of the content on the basis of a user operation description. The application execution section 74 includes a main image generation section 84 to generate a main image frame corresponding to the display viewpoint at a predetermined rate. However, the main image generation section 84 may generate, as a main image frame for display, an image corresponding to a pseudo-viewpoint obtained by shifting the display viewpoint. The main image generation section 84 further generates, as an image for learning, an image of a scene viewed from the pseudo-viewpoint generated by the pseudo-viewpoint generation section 72.

Also in this aspect, the pseudo-viewpoint generation section 72 generates pseudo-viewpoint information in the same format as the viewpoint information supplied from the input information acquisition section 70, and supplies the pseudo-viewpoint information to the application execution section 74. Accordingly, the application execution section 74 can generate images for learning by normal processing without distinguishing between a true display viewpoint and a pseudo-viewpoint. Consequently, the present embodiment can be easily introduced to the conventional content that is not designed for machine learning. However, the function of the pseudo-viewpoint generation section 72 may be deployed in the application execution section 74 via an API or the like, as described above.

The 3D scene information generation section 76 acquires images for learning including a display main image from the application execution section 74, and generates 3D scene information of a scene at each predetermined time step by machine learning such as that described above. Also in this case, the 3D scene information generation section 76 may extract only a region necessary for correcting a display image from the image generated by the main image generation section 84, and uses the extracted region for machine learning. The 3D scene information generated by the 3D scene information generation section 76 is temporarily stored in the 3D scene information storage section 78. The image data transmission section 82 transmits the main image data generated by the main image generation section 84 to the client terminal 10 at a predetermined rate. The 3D scene information data transmission section 86 transmits the 3D scene information data stored in the 3D scene information storage section 78 to the client terminal 10 at a predetermined rate.

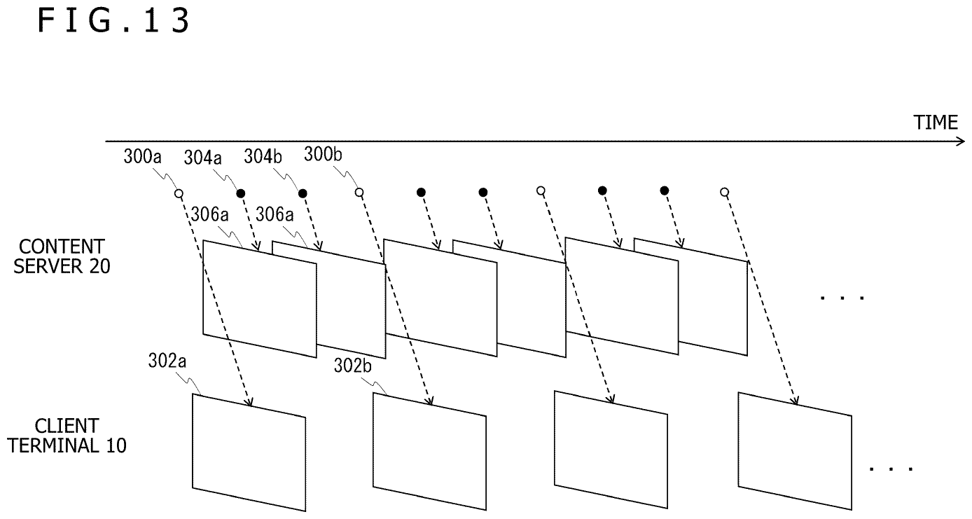

FIG. 13 schematically depicts a sequence of images generated in the present embodiment. In this drawing, the relation between a viewpoint recognized or generated by the content server 20 and the destination of each frame generated based on this viewpoint is depicted along a time axis indicated in the horizontal direction. Similar to FIG. 6, the content server 20 basically generates frames of a display image (e.g., frames 302a and 302b) to correspond to the display viewpoints (e.g., display viewpoints 300a and 300b) which are indicated by white circles, at a predetermined rate, and transmits the generated frames to the client terminal 10. However, the display viewpoints in this case may be substantially pseudo-viewpoints that are deviated from actual display viewpoints. The transmitted images are corrected, if needed, and then displayed at the client terminal 10 side.

In addition, the content server 20 generates images for learning during generation of frames of a display image, that is, during a cycle before generation of the next frame. For example, the content server 20 generates pseudo-viewpoints 304a and 304b indicated by black circles, so as to be processed during processing on the display viewpoints 300a and 300b, and generates images 306a and 306b for learning corresponding to the pseudo-viewpoints 304a and 304b. The content server 20 also uses, as images for learning, frames of a display image to be transmitted to the client terminal 10. As depicted in the drawing, if images are rendered at a rate higher than the display frame rate, images for learning necessary for generating 3D scene information can be efficiently obtained.

For example, in a case where the display frame rate is 60 fps, if the main image generation section 84 works at 120 fps, images for learning twice as many as the frames of the display image can be obtained. If the main image generation section 84 works at 180 fps, images for learning three times as many as the frames of the display image can be obtained. It is to be noted that the depicted example illustrates that display images are transmitted to one client terminal 10, but if a different display viewpoint is defined for images to be transmitted to a different user in, e.g., a multiplayer game, these images can also be used as images for learning. Since the images for learning are efficiently collected in this manner, the accuracy of the 3D scene information representing a scene at each time step can be increased. As a result, high quality images can be displayed.

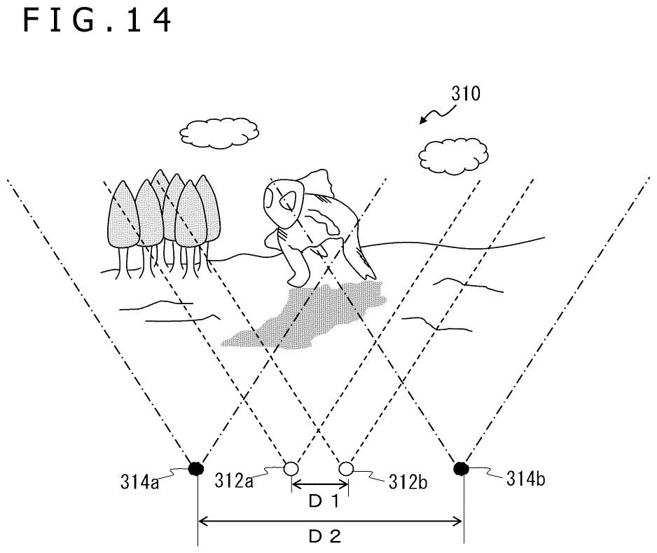

FIG. 14 is a diagram for illustrating an aspect in which a left-eye image and a right-eye image to be displayed on a head mounted display are generated such that the display viewpoints are deviated from each other. FIG. 14 schematically depicts display viewpoints for a scene 310. In a case where a display destination is a head mounted display, display viewpoints 312a and 312b are set with a distance D1 therebetween which is based on the actual distance between eyes such that respective images are generated in visual fields indicated by broken lines. This pair of the images is displayed, on the head mounted display, in positions corresponding to left and right eyes of the users. Accordingly, a stereoscopic view of the scene 310 can be given.

The distance D1 between the display viewpoints 312a and 312b defined in this case, is generally referred to as inter pupillary distance (IPD). For example, the IPD of an adult is approximately 60 mm. However, the IPD depends on individuals, and an IPD can be determined as a variable parameter to a head mounted display in most cases because a preferable stereoscopic view can be realized. Usually, paired images are generated on the basis of the setting value of the IPD. Meanwhile, from normal display viewpoints 312a and 312b, the visual fields for the scene 310 largely overlap, as depicted in the drawing. That is, from the perspective of usage as images for learning, the paired images thus generated based on the above setting value are redundant and inefficient. Therefore, the pseudo-viewpoint generation section 72 set the IPD value to be greatly large, that is, 1 m, for example.

The drawing illustrates that the IPD value is determined to D2 (>D1), and display viewpoints 314a and 314b the distance between which is larger than the distance between the original display viewpoints 312a and 312b are defined. When images are generated based on this setting, information of the scene 310 in a wider range can be obtained as a result of processing on frames at respective time points, as indicated by a dash-dotted line. As a result, 3D scene information with high accuracy can be generated within a short time period. It is to be noted that the display viewpoints 314a and 314b determined here are different from the actual display viewpoints 312a and 312b, and therefore, the image correction section 92 of the client terminal 10 generates display images representing a scene viewed from the display viewpoints 312a and 312b using the 3D scene information, as described above. This aspect can be implemented simply by changing the IPD setting value. Thus, it is sufficient for the application execution section 74 to perform normal processing, and this aspect can be easily applied to conventional content that is not designed for machine learning.

According to the display correction aspect described so far, the content server 20 generates images for learning in parallel with generating display images, and generates 3D scene information of a scene at each time step. The client terminal 10 sequentially acquires the latest 3D scene information from the content server 20, and corrects or renders display images using the 3D scene information. Accordingly, while color change or the like caused by viewpoint change, which cannot be obtained only from the transmitted images, can be precisely expressed, an image that follows movement of the viewpoint can be displayed. In addition, since the client terminal 10 can generate display images with low load, the degree of freedom of viewpoints for which images are generated is increased, so that the content server 20 can more efficiently collect images for learning.

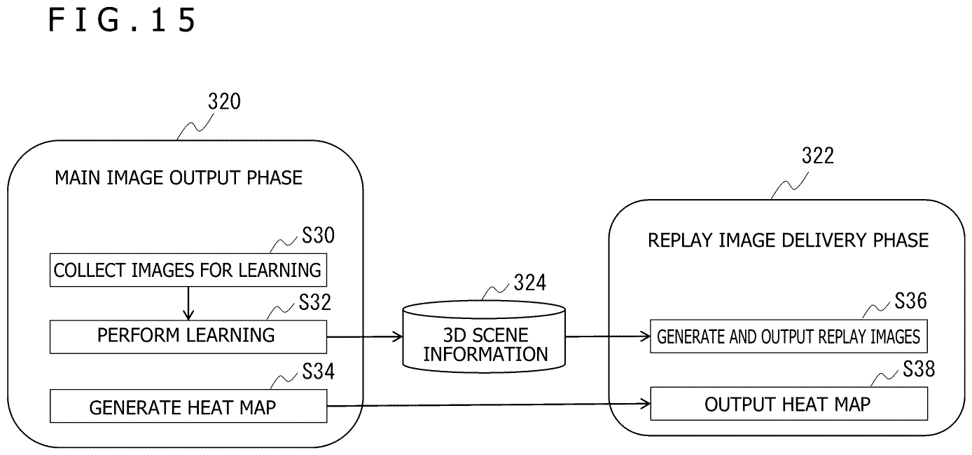

FIG. 15 depicts the outline of a process flow in an aspect in which 3D scene information is used to deliver a replay image. The present aspect is implemented by two separate periods which are a main image output phase 320 and a replay image delivery phase 322. In the main image output phase 320 in which main images of content are being outputted during, for example, a game play, an image processing device or the content server 20 collects images for learning (S30), performs machine learning, thereby generates the 3D scene information 324 representing scenes at respective steps (S32).

It is to be noted that for images for learning collected at S30, the image processing device itself may generate pseudo-viewpoints and perform rendering, as described above. Meanwhile, in an aspect where the content server 20 receives a plurality of display viewpoints and concurrently generates a main image and delivers the image to each client terminal 10 in, e.g., a multiplayer game, the display images may be used as images for learning. Hereinafter, this aspect will be mainly explained. However, also in this case, the content server 20 may additionally set a viewpoint to increase images for learning.

A replay image delivery phase 322 is started when a user request for delivery is given at any timing such as after the end of a game play. It is to be noted that a user who gives a request for delivery of a replay image is not limited to a user such as a game player who has performed an operation in the main image output phase 320. In the replay image delivery phase 322, the content server 20 generates a replay image using the saved 3D scene information 324, and outputs the replay image to the client terminal 10 that has given the delivery request (S36). The 3D scene information is updated at each time step, and an image is generated with a clock time inputted. Then, a moving image can be displayed. Further, in response to a user operation for changing the viewpoint, replay images can be displayed from various positions and directions.

It is to be noted that, in this aspect, when the display world is widened, uneven distribution of display points in the main image output phase 320 occurs. As a result, the 3D scene information 324 with high accuracy is generated in an area having a high density of display viewpoints while the accuracy of the 3D scene information 324 is low in an area having a low density of display viewpoints. Also, the 3D scene information 324 is not generated in an area including no display viewpoint, and thus, a replay image cannot be displayed. Therefore, the content server 20 generates a heat map indicating the magnitude of the density of display viewpoints in the main image output phase 320 (S34). Then, the content server 20 displays the heat map with the replay image in the replay image delivery phase 322 such that the heat map can be checked as a guidance for operating a viewpoint operation (S38).

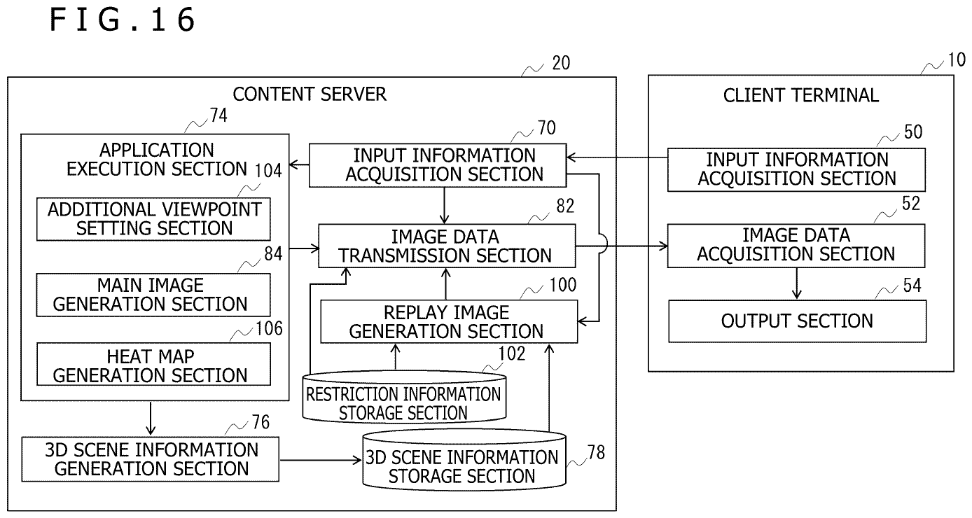

FIG. 16 depicts a functional block configuration of the client terminal 10 and the content server 20 that realizes delivery of a replay moving image. It is to be noted that a block having the same function as the functional block depicted in FIG. 6 is denoted by the same reference sign, and an explanation thereof will be omitted, if needed. Only one client terminal 10 is depicted in the depicted example, but the client terminals of all users who are joining the content are connected to the content server 20, and exert the same function at least in the main image output phase.

The client terminal 10 includes the input information acquisition section 50 that acquires input information such as a user manipulation, an image data acquisition section 52 that acquires image data from the content server 20, and an output section 54 that outputs display image data. The input information acquisition section 50 successively acquires a description of a user operation description from the input device 14. In addition, the input information acquisition section 50 further receives an operation for requesting delivery of a replay image in the replay image delivery phase 322. The input information acquisition section 50 further acquires display viewpoint information for a main image or a replay image from the input device 14 or the head mounted display successively or at a predetermined time interval. The input information acquisition section 50 supplies the acquired information to the content server 20, if needed.

The image data acquisition section 52 acquires display image data from the content server 20. Here, the display image data may include main image data, replay image data, and heat map data. The output section 54 outputs the display image acquired by the image data acquisition section 52 to the display device 16 to display the display image.

The content server 20 includes the input information acquisition section 70 that acquires input information from the client terminal 10, the application execution section 74 that executes an application such as an electronic game, a 3D scene information generation section 76 that generates 3D scene information data, a 3D scene information storage section 78 that stores the generated 3D scene information data, a replay image generation section 100 that generates a replay image, an image data transmission section 82 that transmits data about the display image to the client terminal 10, and a restriction information storage section 102 that stores restriction information concerning delivery of the replay image.

The input information acquisition section 70 acquires information regarding a user operation and a display viewpoint from the client terminal 10 if needed or at a predetermined time interval, and supplies the information to the application execution section 74. The application execution section 74 processes an application of content such as an electronic game in accordance with a user operation description in the main image output phase. The application execution section 74 includes an additional viewpoint setting section 104, a main image generation section 84, and a heat map generation section 106.

The additional viewpoint setting section 104 additionally sets viewpoints for which a main image should be generated, independently of the display viewpoints transmitted from the client terminal 10. The added viewpoint is similar to a pseudo-viewpoint because the added viewpoint is not used for display in the main image output phase, but the added viewpoint is different from a pseudo-viewpoint because the viewpoint which is considered to be necessary for preferably generating a replay image is set according to the content. For example, the additional viewpoint setting section 104 sets an additional viewpoint in a location where an event is likely to occur in a role-playing game such that the accuracy of the 3D scene information representing this location is ensured.

In this manner, the additional viewpoint setting section 104 may predict an event that can occur in the display world, and set an additional viewpoint according to the prediction, or may add a viewpoint in a position where a display viewpoint is unlikely to be put in the main image output phase by taking geographical features in the display world into consideration. The additional viewpoint setting section 104 may further add viewpoints where a display viewpoint cannot be generated, such as a viewpoint for following a virtual user existing in the display world from behind, a viewpoint for looking at a virtual user from diagonally above, or a viewpoint for taking an overhead view of the display world.

In this manner, the additional viewpoint setting section 104 may set a fixed additional viewpoint in the display world and use the additional viewpoint as if using a fixed-point camera, or may set an additional viewpoint that can move according to the state and movement of a virtual user. In addition, the additional viewpoint setting section 104 may set an additional viewpoint according to a program defining the application, or may receive setting of an additional viewpoint as an initial setting of the main image output phase from the user. In either case, if additional viewpoints are set within a range of the processing performance of the content server 20 according to various kinds of standards, the accuracy of the 3D scene information can be increased and the quality of a replay image can be improved. In addition, the user can confirm the situation having occurred in the display world from the position or the direction which has not been viewed in the main image output phase.

The main image generation section 84 generates main image frames at a predetermined rate so as to correspond to the display viewpoint transmitted from the client terminal 10. In addition, the main image generation section 84 generates images of the display world viewed from the viewpoint added by the additional viewpoint setting section 104, at a predetermined rate. The heat map generation section 106 generates a heat map in which the density distribution of a display viewpoint and additionally set viewpoints is indicated on the plane of the display world in the main image output phase. By way of example, the heat map generation section 106 generates a map of an overhead view of the display world such that a region having a high density of display viewpoints, a region having a middle density, a region having a low density, and a region including no display viewpoint are distinguishably color-coded.

When the density of display viewpoints is high, a variety of images for learning can be obtained. As a result, 3D scene information with high accuracy is obtained. Accordingly, the quality of a replay image is supposed to be high. Conversely, even if a viewpoint is set in a location where there is no or few display viewpoint in the replay image delivery phase, a replay image cannot be displayed because 3D scene information has not been generated. Therefore, a heat map is generated in the main image output phase in such a way that the heat map is checked when a viewpoint for a replay image is adjusted. Accordingly, the user can easily set a preferable viewpoint.

In the main image output phase, the 3D scene information generation section 76 uses the images generated by the application execution section 74 as images for learning to be used for the above-mentioned machine learning, thereby generates 3D scene information that represents a scene at each time step. Also in this case, the 3D scene information generation section 76 may extract a region necessary for generating a replay image from the image generated by the main image generation section 84, and uses only the extracted region for machine learning. Further, the 3D scene information generation section 76 may restrict, in the display world, a region for which 3D scene information is to be generated, on the basis of the heat map generated by the heat map generation section 106. Specifically, the 3D scene information generation section 76 may set a target for generation of 3D scene information to an area where the density of display viewpoints or additional viewpoints is greater than a threshold.

The 3D scene information storage section 78 stores the 3D scene information generated by the 3D scene information generation section 76. The 3D scene information storage section 78 stores the 3D scene information data generated at each time step, in association with the time axis of the main image output phase. When a request for replay image delivery is given from the user in the replay image delivery phase, the replay image generation section 100 generates a replay image by the above-mentioned volume rendering using the 3D scene information stored in the 3D scene information storage section 78. The replay image generation section 100 generates a replay image by acquiring the display viewpoint from the input information acquisition section 70 and changing the viewpoint.

Here, the replay image generation section 100 may restrict a delivery time of the replay image and/or the display viewpoint on the basis of the restriction information stored in the restriction information storage section 102. For example, the replay image generation section 100 does not generate the replay image if a predetermined period of time has not elapsed since the end of the main image output phase. Accordingly, an adverse effect that details of the content are known at an early stage and thus an application buying motive is impaired can be suppressed. In addition, the replay image generation section 100 refrains from generating a corresponding replay image when a display viewpoint is adjusted toward a position or a direction in which displaying a replay image is undesirable. In this case, the replay image generation section 100 may generate a display image indicating that the display viewpoint is beyond the restriction.

As an initial process when an application is executed, the replay image generation section 100 reads out restriction information such as that described above from a setting file defining the application, or the like, and stores the read information in the restriction information storage section 102. The image data transmission section 82 transmits main image data generated by the main image generation section 84 to the client terminal 10 at a predetermined rate in the main image output phase. Further, the image data transmission section 82 transmits replay image data generated by the replay image generation section 100 to the client terminal 10 in response to a delivery request in the replay image delivery phase.

Here, the image data transmission section 82 may restrict a delivery destination of a replay image using the 3D scene information on the basis of the restriction information stored in the restriction information storage section 102. For example, the image data transmission section 82 may transmit a replay image using the 3D scene information to only the client terminal 10 of the user who is a participant in the main image output phase. The image data transmission section 82 may transmit an ordinary replay moving image not using the 3D scene information, to the client terminals 10 of the other users. In this case, a replay image from a predetermined display viewpoint is generated, and stored in a storage section (not depicted) in the main image output phase. Also in this aspect, the details of the content can be prevented from easily becoming known.

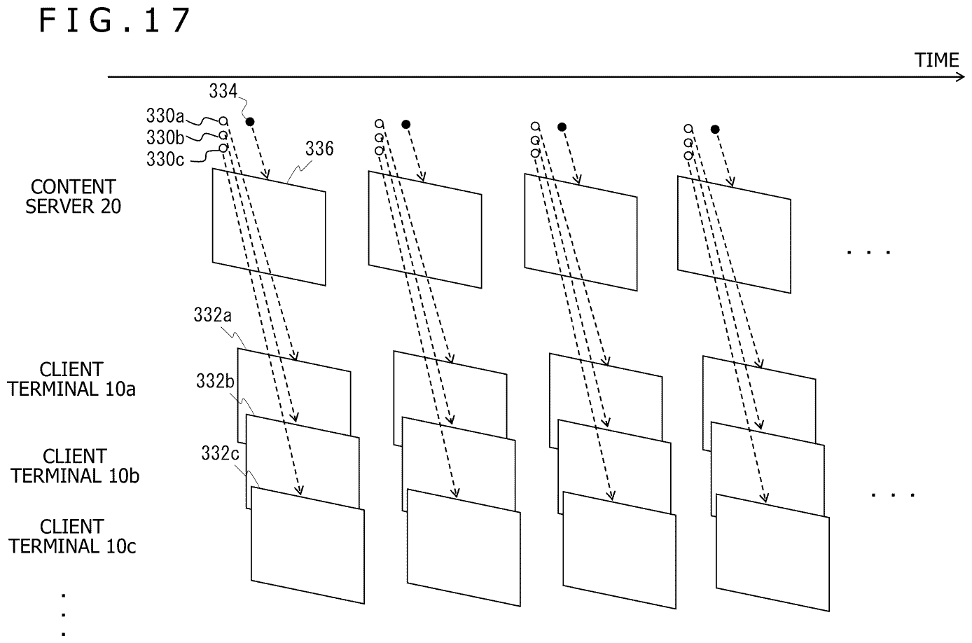

FIG. 17 schematically depicts a sequence of images generated in the main image output phase of the present embodiment. In this drawing, the relation between a viewpoint recognized or generated by the content server 20 and the destination of each frame generated based on this viewpoint is depicted along a time axis indicated in the horizontal direction. In this case, the content server 20 acquires respective display viewpoints (e.g., display viewpoints 330a, 330b, and 330c) from the client terminals 10a, 10b, and 10c . . . . Then, the content server 20 generates frames of a display image (e.g., frames 332a, 332b, and 332c) corresponding to these display viewpoints at a predetermined rate, and transmits the frames of the display image to the respective client terminals 10a, 10b, and 10c . . . . Accordingly, on the client terminals 10a, 10b, and 10c . . . , the common display world viewed from the position and direction of each virtual user, for example, is displayed.

The content server 20 further generates images for learning (e.g., images 336 for learning) at a predetermined rate so as to correspond to viewpoints indicated by black circles (e.g., viewpoints 334) which are additionally set by the additional viewpoint setting section 104. The timing of identifying a plurality of display viewpoints is slightly deviated from the timing of generating additional set viewpoints in the depicted example, but practically, these timings may be the same or may be independent of each other. In addition, the additional viewpoint setting section 104 may practically add many viewpoints.

The 3D scene information generation section 76 performs machine learning using, as images for learning, frames of a display image to be transmitted to the client terminals 10 and images corresponding to the additional viewpoint. For example, for an MMO (Massively Multiplayer Online) game in which there are at least 100 players, at least 100 images for learning are collected per frame. Accordingly, images for learning can be efficiently collected, the accuracy of 3D scene information representing a scene at each time step is increased, and thus, the quality of a replay image can be easily maintained with respect to viewpoint change.

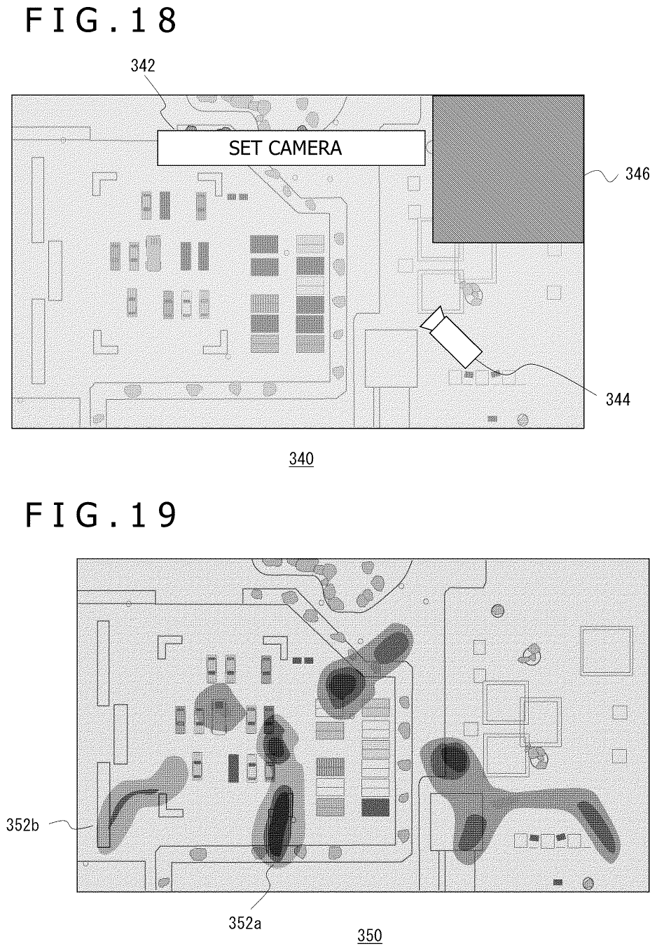

FIG. 18 depicts an example of a screen that the additional viewpoint setting section 104 of the content server 20 displays to receive setting of an additional viewpoint from a user. In this example, an additional viewpoint reception screen 340 has a configuration in which a camera icon 344 and a message 342 prompting for additional viewpoint setting are superimposed on a base image which is a map of an overhead view of a display world. On the client terminal 10, the user puts the icon 344 in a desired position and a desired direction by, for example, moving the icon 344 through the input device 14. In response to this, the additional viewpoint setting section 104 sets the additional viewpoint in the corresponding position and direction in the three-dimensional space of the display world.

The additional viewpoint reception screen 340 further includes a viewpoint setting prohibition region 346. The additional viewpoint setting section 104 performs control to prohibit a user from putting an icon 344 in the prohibition region 346. Accordingly, a problem that a viewpoint is set in an inappropriate position and display becomes possible, or a problem that unnecessary images for learning are generated can be prevented. The position and shape of the prohibition region 346 in the display world is previously defined in an application setting file or the like. It is to be noted that the depicted example is a reception screen to fixedly set an additional viewpoint, but the type of an additional viewpoint that can be received from the user is not limited. For example, an additional viewpoint may be set, for example, behind a virtual user in the display world. In this case, the additional viewpoint setting section 104 may provide choices of viewpoint types with letters or the like such that the user can choose and input a type.

FIG. 19 depicts an example of a heat map that is generated by the heat map generation section 106 of the content server 20. In this example, the heat map 350 is formed by superimposing, on a base image which is a map of an overhead view of the display world, regions (e.g., regions 352a and 352b) where display viewpoints are distributed in colors the degrees of depths of which correspond to the respective density levels. It is to be noted that different colors such as red, yellow, blue, etc., may be actually used to represent the respective density levels. As depicted in the drawing, in a case where a deviation exists in regions where display viewpoints, that is, virtual users exist in the display world, most of such regions are not suitable for generation of 3D scene information. Therefore, the heat map generation section 106 sets, for example, a colorless region where the density of display viewpoints is equal to or less than a threshold, such that any viewpoint is prohibited from being set in the replay image delivery phase.

The 3D scene information for a region where the density of viewpoints is high can be generated with high accuracy, and the content is supposed to be lively. Therefore, by setting the display viewpoint in such a location, the user viewing the replay image can enjoy the high quality replay image of the lively scene even if the display world is wide. It is to be noted that the heat map generation section 106 may update the heat map at a predetermined rate according to a change in the distribution of display viewpoints.

In this case, when a replay image is delivered, a moving image of the heat map is delivered in synchronization with the replay image, whereby the user can appropriately determine display viewpoint corresponding to the change in the density distribution. This aspect is suitable for content in which the movable range of a virtual user in a display world is wide and the density distribution often changes. On the other hand, in content in which the movable range of a virtual user is narrow, the heat map generation section 106 may integrate heat maps of respective time steps and deliver a static image of the resultant heat map.

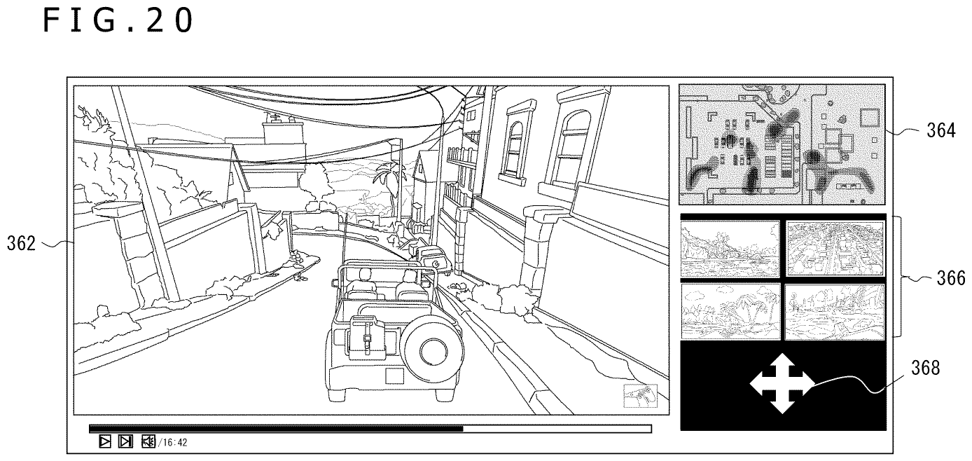

FIG. 20 illustrates a replay image display screen to be displayed on the display device 16 in a replay image delivery phase. Conventionally, as a delivered image of, e.g., a game, it is common to view a moving image having a defined display viewpoint on a moving image viewing platform via a browser. It is difficult to realize the present embodiment on such a common platform because the present embodiment has the feature of receiving a viewpoint operation for a replay image.

For this reason, a specific platform in which a user interface (UI) for adjusting a viewpoint is disposed on a browser is provided such that a replay image can be enjoyed by means of a general-purpose device such as a personal computer, a tablet terminal, or a mobile phone. In this case, the content server 20 transmits data of settings of the replay image, the heat map, and the UI in a markup language such as hypertext markup language (HTML), to the client terminal 10. The client terminal 10 generates a replay image display screen by a browser, and displays the replay image display screen on the display device 16. The viewpoint adjustment information is transmitted from the client terminal 10 to the content server 20 as required, and the corresponding data is transmitted from the content server 20 to the client terminal 10.

In the depicted example, the replay image display screen 360 includes a replay image section 362, a heat map section 364, a candidate viewpoint section 366, and a viewpoint adjustment UI 368. A delivered replay image is displayed in the replay image section 362. The viewpoint for the scene being displayed can be changed by the user operating the viewpoint adjustment UI 368. In this example, the viewpoint adjustment UI 368 is a direction indicating key that can indicate movement of the viewpoint to four directions. For example, when an upward arrow portion is indicated, the viewpoint moves forward. When a rightward arrow direction is indicated, the viewpoint rotates rightward.

However, the shape and configuration of the viewpoint adjustment UI 368 is not limited to this. For example, the position of the viewpoint and the direction of the view line may be separately adjusted, or an elevation/depression angle or azimuthal angle or a distance may be changed with respect to an object fixedly located in the center of the view field. In addition, the viewpoint adjustment UI 368 is not limited to graphical user interfaces (GUIs), and choices indicating the viewpoint type, such as a viewpoint following from behind a key object or a viewpoint having an overhead view of the entire world, are provided with letters such that the user is allowed to input a choice.

A heat map is displayed in the heat map section 364. As described above, the heat map represents the density distribution of display viewpoints in the main image output phase, and serves as an indicator for the quality of a replay image using 3D scene information. Therefore, the position of the viewpoint can be designated also on the displayed heat map. If a point on the heat map is indicated by the user using a cursor that is not depicted or a touch operation, the viewpoint of the replay image displayed in the replay image section 362 is moved to the indicated position.

From the heat map, the user can intuitively discern a location for which 3D scene information is not acquired or a location for which the accuracy of 3D scene information is low. Therefore, by setting a viewpoint in a region having the high density, the user can easily view a lively scene with high quality. It is to be noted that an operation to be received using the heat map is not limited to a designation of the position of a viewpoint, and a designation of a view line direction also may be received. In this case, for example, a camera icon or an arrow is superimposed on the heat map such that the view line direction can be designated by an operation of changing the direction of the icon or arrow.

In addition, for a region having the high density of display viewpoints, it is likely that high quality 3D scene information is generated irrespective of direction. Therefore, the view line may be changeable to every direction in a case where the viewpoint is set in a region having the highest density level while the movable range of the view direction may be restricted in the remaining regions. When the viewpoint position or the view line direction is adjusted through the viewpoint adjustment UI 368, an arrow superimposed on the heat map may follow this adjustment.

Accordingly, a relation between the replay image being displayed and the viewpoint in the display world can be intuitively discerned. In addition, when the viewpoint position or the view line direction goes beyond the restriction range as a result of adjustment of the viewpoint, a concealment object may be displayed in the corresponding region in the view field of the replay image being displayed.

It is to be noted that particularly when the display world is wide, an operation for zooming in/out the heat map or for moving the display range may also be received. The candidate viewpoint section 366 displays, as a generally-called “recommendation,” a thumbnail view of a replay image from the viewpoint selected by the content server 20 in accordance with a predetermined criterion. For example, in a region having the highest-level density in the heat map is selected, and thumbnail views of replay images viewed from a few viewpoints within the selected region are displayed in the candidate viewpoint section 366. Alternatively, a replay image in which a virtual user in the display world or a predetermined player is included in the field angle may be displayed. It is to be noted that from which position and direction of a viewpoint is set for the replay image displayed in the candidate viewpoint section 366 may be indicated in the heat map.

If any one of the thumbnail images is selected by the user using a cursor that is not depicted or a touch operation, the display viewpoint is switched. Thus, the displayed thumbnail image of the replay image is displayed in the replay image section 362. It is to be noted that, in a case where the viewpoint position is designated on the heat map or in a case where a thumbnail image is selected in the candidate viewpoint section 366, there is a possibility that the viewpoint is discontinuously displaced from the replay image displayed in the replay image section 362.

Here, the content server 20 may generate a path smoothly connecting the original viewpoint to a new viewpoint, move the viewpoint therealong, and display a replay image representing the movement process. For example, the content server 20 temporarily moves the viewpoint to the above, and then moves downward to the position of the new viewpoint. As a result of these effects, a joy specific to the replay image is produced to improve the quality of the viewing experience.

According to the aspect of delivering a replay moving image described so far, the content server 20 collects, as images for learning, main image frames transmitted to a plurality of client terminals 10, and image frames corresponding to additionally set viewpoints in the main image output phase, and generates 3D scene information of scenes at respective time steps. Accordingly, a replay image viewed from an arbitrary viewpoint can be delivered. In addition, the content server 20 generates a heat map indicating the density distribution of display viewpoints for a main image while performing learning concurrently. The magnitude of the density of display viewpoints is linked to the magnitude of the accuracy of the 3D scene information and the degree of prosperity in a scene. Therefore, the heat map is displayed concurrently with the replay image such that the heat map can serve as a basis for adjustment of a viewpoint with respect to the replay image. Accordingly, a lively scene can be viewed with high quality even if the display world is wide.

In addition, the content server 20 provides a platform for viewing a replay moving image through a general browser and allowing adjustment of the viewpoint. On a screen displayed by this platform, a UI for adjusting a viewpoint, a heat map, and a thumbnail image of a recommended viewpoint are displayed. Accordingly, even in an environment where a device of a certain type such as a game device does not exist, a replay image can be viewed while a viewpoint operation is easily being performed by means of a general-purpose device.

In the above-mentioned aspects in which a saved scene is viewed and a replay moving image is viewed, the display from a free viewpoint is enabled by, basically, learning main images of content and generating 3D scene information. However, the process of additionally setting a viewpoint different from the original display viewpoint outside the application execution section, and the process enabling movement of the free viewpoint using the generated 3D scene information in order to acquire images for learning, incur the risk of exposing the outside of a viewing permitted range of the display world that is originally assumed in the content.

If a user selects a viewpoint for an overhead view of the display world in a replay image of, for example, a role-playing game, the user may look at a place to be reached in the future, and then loose interest or loose motivation for buying the application. In addition, according to the content, the state of a created image, and the like, there are many viewpoints not desired by the content developer, such as an enemy character's viewpoint or a viewpoint approaching a background object.

Therefore, in the present aspect, restrictions are intendedly imposed on setting of viewpoints for generating images for learning and/or setting of display viewpoints for images using 3D scene information. By reading out, for each content, the restriction information defined by the developer of the content, the content server 20 uses the restriction information when setting a viewpoint or adding the restriction information as metadata to the 3D scene information. The present aspect can be combined with the above-mentioned aspects in which a scene is saved and a replay moving image is delivered. Similarly to these aspects, the present aspect will be explained based on the main image output phase and an arbitrary viewpoint image viewing phase using 3D scene information.

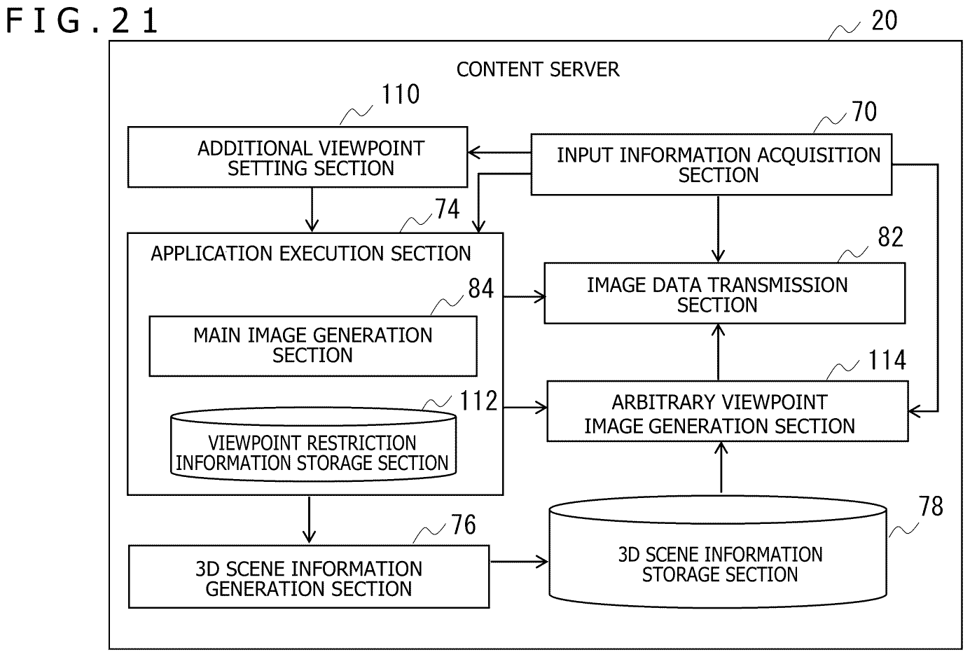

FIG. 21 depicts a functional block configuration of the content server 20 in an aspect in which a display viewpoint is restricted by an application. It is to be noted that a block having the same function as the functional block depicted in FIG. 6 is denoted by the same reference sign, and an explanation thereof will be omitted, if needed. Further, the client terminal 10 is the same as those depicted in FIGS. 5 and 16, and therefore, the illustration thereof is omitted. The functional blocks depicted in this drawing may be combined with either the content server 20 depicted in FIG. 5, which implements scene saving by a user or the content server 20 depicted in FIG. 16, which implements replay image delivery. In addition, at least part of the depicted functions may be realized by the client terminal 10, as described above, and thus, the subject of the processing is not limited to the content server 20.

The content server 20 includes an input information acquisition section 70 that acquires input information from the client terminal 10, an additional viewpoint setting section 110 that generates a viewpoint for generating an image for learning, an application execution section 74 that executes an application such as an electronic game, a 3D scene information generation section 76 that generates 3D scene information data, a 3D scene information storage section 78 that stores generated 3D scene information data, an arbitrary viewpoint image generation section 114 that generates an arbitrary viewpoint using 3D scene information, and an image data transmission section 82 that transmits display image data to the client terminal 10. It is to be noted that the functional blocks other than the application execution section 74 may be collectively referred to as system section because these functional blocks are responsible for peripheral processing necessary for the system side of the content server 20, i.e., the application execution section 74 to execute an application.

First, in the main image output phase, the application execution section 74 processes a content application such as an electronic game on the basis of a user operation description. Here, the application execution section 74 includes a main image generation section 84 that generates a frame of a main image, and further, a viewpoint restriction information storage section 112 that stores viewpoint restriction information defined in development of an application and associated with the application program. The viewpoint restriction information is information for imposing restrictions on viewpoints that are set when images for learning are generated in the main image output phase, and/or display viewpoints that are adjusted in the arbitrary viewpoint image output mode. Such restrictions may be imposed on viewpoint positions and/or view line directions.

For example, in the content development phase, the content server 20 provides a screen for setting viewpoint restrictions to a terminal of a developer (not depicted), and the developer inputs restriction information on the setting screen. Restriction candidates may be displayed on the setting screen to allow the developer to make a selection or input a numerical value only, as appropriate, so that a time for setting the restriction information can be saved. Accordingly, the developer can easily make the detailed setting that, for example, “view lines in every direction a position within a 1 to 3 m-radius from a virtual player is allowed.” The movable range of the viewpoint is not limited to such a fixed region in the display world, and a range that moves or deforms according to the situation may be adopted. That is, the restriction information may be configured to designate a fixed region in the display world, or may be configured to define the variation of the restricted range of the viewpoint.

The input information acquisition section 70 acquires user operation description and display viewpoint information from the client terminal 10 successively or a predetermined time interval. The additional viewpoint setting section 110 has the similar function to the pseudo-viewpoint generation section 72 depicted in FIG. 5 or the additional viewpoint setting section 104 depicted in FIG. 16, and sets a viewpoint for generating an image for learning. That is, a viewpoint set by the additional viewpoint setting section 110 may be based on a display viewpoint transmitted from the client terminal 10, or may be based on the content substance such as the configuration of the display world.

To perform the setting, the additional viewpoint setting section 110 reads out the viewpoint restriction information from the viewpoint restriction information storage section 112 of the application execution section 74, and sets the viewpoint within the allowed range. Alternatively, for each viewpoint generated, the additional viewpoint setting section 110 may inquire the application execution section 74 about the permission/rejection of the setting via the API. The additional viewpoint setting section 110 supplies information concerning the additional viewpoint having set in this manner, to the application execution section 74.

The main image generation section 84 generates an image corresponding to the display viewpoint transmitted from the client terminal 10 and an image corresponding to the viewpoint additionally set by the additional viewpoint setting section 110 at respective predetermined rates in the main image output phase. As described above, since the additional viewpoint setting section 110 generates the additional viewpoint information in the same manner as that viewpoint information supplied from the input information acquisition section 70 and supplies the additional viewpoint information to the application execution section 74. Accordingly, the application execution section 74 can generate images for learning by normal processing without distinguishing between a true display viewpoint and an additional viewpoint.

The 3D scene information generation section 76 generates 3D scene information of a scene to be saved, by perform the above-mentioned machine learning using the images generated by the application execution section 74 as images for learning. The 3D scene information storage section 78 stores the 3D scene information generated by the 3D scene information generation section 76. The arbitrary viewpoint image generation section 114 generates an arbitrary viewpoint image by the above-mentioned volume rendering using the 3D scene information stored in the 3D scene information storage section 78, in the arbitrary viewpoint image viewing phase.

Here, the arbitrary viewpoint image generation section 114 acquires the display viewpoint from the input information acquisition section 70, and generates the arbitrary viewpoint image while changing the viewpoint according to the acquired display viewpoint. To generate the image, the arbitrary viewpoint image generation section 114 reads out the viewpoint restriction information from the viewpoint restriction information storage section 112 of the application execution section 74, and generates the image from the viewpoint only within the permitted range. Alternatively, for each display viewpoint, the arbitrary viewpoint image generation section 114 may inquire the application execution section 74 about the permission/rejection of the setting via the API.

In a range where setting of an additional viewpoint is not permitted in the main image output phase, it is likely that images for learning are insufficient and the accuracy of 3D scene information is not high. Therefore, when the arbitrary viewpoint image is generated, generation of a display image from a viewpoint located within this range is prohibited. Accordingly, a problem that, for example, the quality of a new image that is included in the view field as a result of viewpoint adjustment is suddenly degraded can be avoided. In contrast, even if restrictions on display viewpoints are canceled as a result of a certain unauthorized operation, setting additional viewpoints for generation of images for learning is not permitted. The details of this region are not visually recognized as long as detailed 3D scene information is not generated.

With the viewpoint restriction information, restrictions are imposed on both a viewpoint to be set for generation of images for learning and a display viewpoint to be adjusted when an arbitrary viewpoint image is generated in this manner. Accordingly, a risk that the display world is displayed at a field angle that is not desired by the content developer can be further reduced. However, the present disclosure is not limited to this, as described above, and restrictions may be imposed on only one of these viewpoints. It is to be noted that when the display viewpoint transmitted from the client terminal 10 reaches the boundary of the restricted range in the arbitrary viewpoint image viewing phase, the arbitrary viewpoint image generation section 114 may stop movement of the display viewpoint. Alternatively, the arbitrary viewpoint image generation section 114 may conceal the region of a new image that is included in the view field when the restriction range is exceeded, by superimposing, for example, a concealment object thereon.

The image data transmission section 82 transmits main image data generated by the main image generation section 84 to the client terminal 10 at a predetermined rate in the main image output phase. Further, the image data transmission section 82 transmits the arbitrary viewpoint image data generated by the arbitrary viewpoint image generation section 114 to the client terminal 10 in the arbitrary viewpoint image viewing phase.

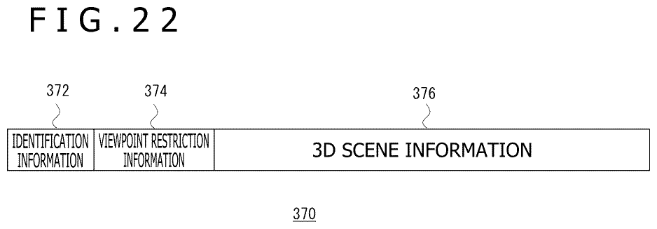

It is to be noted that the 3D scene information generation section 76 may read out the viewpoint restriction information from the viewpoint restriction information storage section 112, and store the viewpoint restriction information as metadata for the generated 3D scene information, in the 3D scene information storage section 78. FIG. 22 is a diagram illustrating a data structure of display 3D scene information data in the present embodiment. Display 3D scene information data 370 includes an identification information field 372, a viewpoint restriction information field 374, and a 3D scene information field 376. The identification information field 372 stores various information for identifying the 3D scene information, such as an identification number of the 3D scene information, identification information of the original content, identification information of a user having requested for generation, etc.

The viewpoint restriction information field 374 stores viewpoint restriction information read out from the viewpoint restriction information storage section 112 by the 3D scene information generation section 76. The 3D scene information field 376 stores the entity of the 3D scene information generated by the 3D scene information generation section 76. In this case, the arbitrary viewpoint image generation section 114 first checks the identification information field 372 to identify 3D scene information corresponding to a user request and reads out the information from the 3D scene information storage section 78. The arbitrary viewpoint image generation section 114 further reads out viewpoint restriction information from the viewpoint restriction information field 374, confirms the appropriateness/inappropriateness of the display viewpoint, and then if the display viewpoint is within the restricted range, generates a display image using the 3D scene information stored in the 3D scene information field 376.

Since the 3D scene information is associated with the viewpoint restriction information, the arbitrary viewpoint image generation section 114 can generate an arbitrary viewpoint image while properly restricting viewpoints, even in an environment where the application execution section 74 is lacked. Alternatively, in an aspect in which the display 3D scene information data 370 itself is transmitted to the client terminal 10 or another content server 20 or a recording medium storing the data 370 is circulated, restrictions on viewpoints desired by a developer of the original content can be observed by the arbitrary viewpoint image generation section 114 included in a device used for displaying an arbitrary viewpoint image.

According to the present aspect described so far, when content is started, viewpoint restriction information is determined by inferring the substance of the content. As a result, when a viewpoint for images for learning is set outside the application execution section 74 or 3D scene information obtained by learning is used to generate an arbitrary viewpoint display image, unintended display of an image in a view field that is not desired by the content developer can be prevented. In addition, since the restriction information is added to the 3D scene information, restrictions on viewpoints during display can be imposed, irrespective of image display environment using the 3D scene information.

The present disclosure has been explained so far on the basis of the embodiment. The embodiment exemplify the present disclosure but a person skilled in the art will understand that various modifications can be made to a combination of the constituent elements or the process steps of the embodiment and that these modifications are also within the scope of the present disclosure.

As described so far, the present disclosure can be used for any information processing device such as a content server, a game device, a head mounted display, a display device, a mobile terminal, or a personal computer, or for an image display system including any one of them.

What is claimed is:

1. A device comprising:
at least one processor; and
a memory device storing instructions that, when executed by the at least one processor, cause the device to:
generate a frame of a display image at a predetermined rate, the display image representing a three-dimensional display world, wherein a state of the three-dimensional display world changes in accordance with an operation at a viewpoint;
generate a pseudo-viewpoint different from the viewpoint generate an image for learning corresponding to the pseudo-viewpoint; and
generate three-dimensional scene information by machine learning using the image for learning as training data, the three-dimensional scene information representing three-dimensional information associated with the display world.

2. The device according to claim 1, wherein the instructions that, when executed by the at least one processor, further cause the device to:
generate the three-dimensional scene information representing three-dimensional information of a scene in accordance with a saving request of the scene being displayed;
store data of the three-dimensional scene information in the memory device; and
using the three-dimensional scene information, generate a display image representing the scene viewed from an arbitrary viewpoint.

3. The device according to claim 2, wherein the instructions that, when executed by the at least one processor, further cause the device to:
generate the images for learning representing the scene viewed from a plurality of directions, by arranging a plurality of the pseudo-viewpoints according to a predetermined rule based on an image being displayed, in accordance with the saving request.

4. The device according to claim 2, wherein the instructions that, when executed by the at least one processor, further cause the device to:
generate a predetermined number of the images for learning after stopping generation of the frame of the display image in accordance with the saving request.

5. The device according to claim 4, wherein the instructions that, when executed by the at least one processor, further cause the device to:
generate the images for learning at a rate higher than a rate of the frame of the display image.

6. The device according to claim 4, wherein the instructions that, when executed by the at least one processor, further cause the device to:
generate a standby image while generation of the frame of the display image is stopped.

7. The device according to claim 1, wherein the instructions that, when executed by the at least one processor, further cause the device to:
extract a region for use while generating of the three-dimensional scene information from the images for learning; and
use the extracted region for machine learning.

8. The device according to claim 1, wherein the instructions that, when executed by the at least one processor, further cause the device to:
generate the three-dimensional scene information at a predetermined rate, further comprising:
correct or generate the frame of the display image immediately before displaying, using the latest three-dimensional scene information.

9. The device according to claim 8, wherein the instructions that, when executed by the at least one processor, further cause the device to:
generate a predetermined number of the images for learning during a generation cycle of the frame of the display image.

10. The device according to claim 8, wherein the instructions that, when executed by the at least one processor, further cause the device to:
render an image of a region lacking in the display using the three-dimensional scene information based on movement of the viewpoint.

11. The device according to claim 1, wherein the instructions that, when executed by the at least one processor, further cause the device to:
generate a pair of display images for a left eye and a right eye according to a setting value of an interpupillary distance, and
generate the pseudo-viewpoint by changing the setting value of the interpupillary distance.

12. The device according to claim 1, wherein the instructions that, when executed by the at least one processor, further cause the device to:
acquire information of each viewpoint defining each display image from each client terminal of a plurality of client terminal;
sequentially transmit data of the frame of the display image generated corresponding to each viewpoint, to each client terminal of the client terminal; and
use the display image as the image for learning.

13. The device according to claim 1, wherein the instructions that, when executed by the at least one processor, further cause the device to:
generate, as the three-dimensional scene information, a neural network using Neural Radiance Fields (NeRF).

14. A method comprising:
generating a frame of a display image at a predetermined rate, the display image representing a three-dimensional display world, wherein a state of the three-dimensional display world changes in accordance with an operation at a viewpoint;
generating a pseudo-viewpoint different from the viewpoint;
generating an image for learning corresponding to the pseudo-viewpoint; and
generating three-dimensional scene information by machine learning using the image for learning as training data, the three-dimensional scene information representing three-dimensional information associated with the display world.

15. The method of claim 14, further comprising:
generating the three-dimensional scene information representing three-dimensional information of a scene in accordance with a saving request of the scene being displayed;
storing data of the three-dimensional scene information in the memory device; and
generating a display image representing the scene viewed from an arbitrary viewpoint based on the three-dimensional scene information.

16. The method of claim 14, further comprising:
generating the three-dimensional scene information at a predetermined rate; and
correcting or generating the frame of the display image immediately before displaying, using the latest three-dimensional scene information.

17. The method of claim 14, further comprising:
generating a pair of display images for a left eye and a right eye according to a setting value of an interpupillary distance, and
generating the pseudo-viewpoint by changing the setting value of the interpupillary distance.

18. The method of claim 14, further comprising:
acquiring information of each viewpoint defining each display image from each client terminal of a plurality of client terminal;
sequentially transmitting data of the frame of the display image generated corresponding to each viewpoint, to each client terminal of the client terminal; and
using the display image as the image for learning.

19. The method of claim 14, further comprising:
generating, as the three-dimensional scene information, a neural network using Neural Radiance Fields (NeRF).

20. A non-transitory computer-readable medium storing computer-readable instructions that, when executed by a computer, cause the computer to perform operations comprising:
generating a frame of a display image at a predetermined rate, the display image representing a three-dimensional display world, wherein a state of the three-dimensional display world changes in accordance with an operation at a viewpoint;
generating a pseudo-viewpoint different from the viewpoint;
generating an image for learning corresponding to the pseudo-viewpoint; and
generating three-dimensional scene information by machine learning using the image for learning as training data, the three-dimensional scene information representing three-dimensional information associated with the display world.
